(19) United States
(12) Patent Application Publication
(10) Pub. No.: US 2026/0304492 A1
(43) Pub. Date: Oct. 1, 2026

(54) Network Assisted D-MIMO Radio Access

(71) Applicant: Telefonaktiebolaget LM Ericsson (publ), Stockholm (SE)

(72) Inventors: Magnus Åström, Lund (SE); Joao Vieira, Hjärup (SE); Muris Sarajlic, Malmö (SE)

(21) Appl. No.: 19/477,639

(22) PCT Filed: Apr. 24, 2024
(86) PCT No.: PCT/EP2024/061242

§ 371 Date: Oct. 22, 2025

(30) Foreign Application Priority Data
Apr. 26, 2023 (SE) 2330182-3

(51) Int. Cl. H04W 74/0833; H04B 7/024

(52) U.S. Cl. CPC H04W 74/0833; H04B 7/024

(57) ABSTRACT

A method is disclosed for a communication network comprising a radio access node and a D-MIMO system. The radio access node causes the D-MIMO system to monitor transmission of a random access message (714) from a wireless communication device, and a control unit (CU) of the D-MIMO system configures (710) a first set of access points (APs) of the D-MIMO system accordingly. Each AP in the first set monitors the random access message, and transmits a monitor report (716) to the CU for selection (718) of a second set of APs to be configured (720) for subsequent communication with the wireless communication device. The radio access node transfers (722) radio access responsibility for the subsequent communication to the D-MIMO system, including transmission of a reply (724) to the random access message. Corresponding apparatuses and computer program products are also disclosed; as well as a wireless communication device, a network node, a D-MIMO CU, D-MIMO APs, a D-MIMO system, and a radio access system.

### TECHNICAL FIELD

The present disclosure relates generally to the field of wireless communication. More particularly, it relates to radio access via a distributed multiple-input multiple-output (D-MIMO) system comprised in a communication network.

### BACKGROUND

Typically, cellular communication network deployments comprise radio access nodes (e.g., base stations, or the like) for provision of wireless communication services to one or more wireless communication devices (e.g., user equipment, UEs). In some situations, a cellular communication network deployment may be supplemented by a distributed multiple-input multiple-output, D-MIMO, system (e.g., for improved capacity). Initial access, via a random access protocol, is executed in relation to a radio access node or the D-MIMO system when a wireless communication device needs communication connection.

A problem with initial access in relation to a D-MIMO system is that the signaling overhead needed to enable initial access may be substantial. For example, system information signaling typically needs to be broadcast from each access point (AP) of the D-MIMO system.

Therefore, there is a need for alternative approaches to initial access in relation to a D-MIMO system.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method for a wireless communication device configured for operation in association with a communication network, wherein the communication network comprises a radio access node and a distributed multiple-input multiple-output (D-MIMO) system. The method comprises receiving (from the radio access node) a configuration for multi-directional transmission of a random access message, transmitting the random access message in two or more directions using a respective random access message resource for each direction, receiving (from an access point of the D-MIMO system) a reply to the random access message in a reply resource, wherein the reply resource indicates one of the two or more directions by being associated with one of the respective random access message resources, and using the indicated direction for subsequent communication via the D-MIMO system.

In some embodiments, the configuration for multi-directional transmission of the random access message is comprised in a second random access protocol message, and/or the random access message is a third random access protocol message, and/or the reply to the random access message is a fourth random access protocol message.

In some embodiments, the configuration for multi-directional transmission of the random access message is comprised in a system information signaling, and/or the random access message is a first random access protocol message, and/or the reply to the random access message is a second random access protocol message.

A second aspect is a method for a radio access node configured for operation within a communication network, wherein the communication network comprises the radio access node and a distributed multiple-input multiple-output (D-MIMO) system. The method comprises causing the D-MIMO system to monitor transmission of a random access message from a wireless communication device, and transferring (to the D-MIMO system) radio access responsibility for subsequent communication with the wireless communication device.

In some embodiments, the method further comprises determining to attempt radio access via the D-MIMO system for the wireless communication device, wherein the D-MIMO system is caused to monitor transmission of the random access message from the wireless communication device responsive to the determination.

In some embodiments, determining to attempt radio access via the D-MIMO system for the wireless communication device is responsive to a traffic load of the radio access node exceeding a load threshold, and/or responsive to a wireless communication device location indication falling within a coverage area of the D-MIMO system.

In some embodiments, the method further comprises transmitting (to the wireless communication device) a configuration for multi-directional transmission of the random access message.

In some embodiments, the configuration for multi-directional transmission of the random access message is comprised in a second random access protocol message, and/or the random access message is a third random access protocol message.

In some embodiments, causing the D-MIMO system to monitor transmission of the random access message from the wireless communication device comprises transmitting a monitor request message to the D-MIMO system.

In some embodiments, the configuration for multi-directional transmission of the random access message is comprised in a system information signaling, and/or the random access message is a first random access protocol message.

In some embodiments, causing the D-MIMO system to monitor transmission of the random access message from the wireless communication device comprises providing random access resource information to the D-MIMO system and/or transmitting a monitor trigger message to the D-MIMO system.

A third aspect is a method for a control unit (CU) of a distributed multiple-input multiple-output (D-MIMO) system configured for operation within a communication network, wherein the communication network comprises a radio access node and the D-MIMO system. The method comprises configuring a first set of access points (APs) of the D-MIMO system to monitor transmission of a random access message from a wireless communication device, receiving respective monitor reports from the first set of APs, selecting a second set of APs of the D-MIMO system based on the monitor reports, configuring the second set of APs for subsequent communication with the wireless communication device, and taking over radio access responsibility for subsequent communication with the wireless communication device.

In some embodiments, the random access message is a third random access protocol message.

In some embodiments, the method further comprises receiving a monitor request message from the radio access node, wherein configuring the first set of APs is responsive to the reception of the monitor request. In some embodiments, the random access message is a first random access protocol message.

In some embodiments, the method further comprises receiving random access resource information and/or a monitor trigger message from the radio access node, wherein configuring the first set of APs is responsive to the reception of the random access resource information and/or the monitor trigger message.

A fourth aspect is a method for an access point (AP) of a distributed multiple-input multiple-output (D-MIMO) system configured for operation within a communication network, wherein the communication network comprises a radio access node and the D-MIMO system. The method comprises receiving (from a control unit, CU, of the D-MIMO system) a configuration to monitor a random access message from a wireless communication device, monitoring the random access message from the wireless communication device, transmitting a monitor report to the CU, and receiving (from the CU) a configuration for subsequent communication with the wireless communication device, wherein the subsequent communication comprises transmitting (to the wireless communication device) a reply to the random access message in a reply resource associated with a random access message resource in which the random access message was received during the monitoring.

In some embodiments, the random access message is a third random access protocol message, and/or the reply to the random access message is a fourth random access protocol message.

In some embodiments, the random access message is a first random access protocol message, and/or the reply to the random access message is a second random access protocol message.

A fifth aspect is a computer program product comprising a non-transitory computer readable medium, having thereon a computer program comprising program instructions. The computer program is loadable into a data processing unit and configured to cause execution of the method according to any of the first through fourth aspects when the computer program is run by the data processing unit.

A sixth aspect is an apparatus for a wireless communication device configured for operation in association with a communication network, wherein the communication network comprises a radio access node and a distributed multiple-input multiple-output (D-MIMO) system. The apparatus comprises controlling circuitry configured to cause reception (from the radio access node) of a configuration for multi-directional transmission of a random access message, transmission of the random access message in two or more directions, using a respective random access message resource for each direction, reception (from an access point of the D-MIMO system) of a reply to the random access message in a reply resource, wherein the reply resource indicates one of the two or more directions by being associated with one of the respective random access message resources, and use of the indicated direction for subsequent communication via the D-MIMO system.

A seventh aspect is a wireless communication device comprising the apparatus of the sixth aspect.

An eighth aspect is an apparatus for a radio access node configured for operation within a communication network, wherein the communication network comprises the radio access node and a distributed multiple-input multiple-output (D-MIMO) system. The apparatus comprises controlling circuitry configured to cause the D-MIMO system to monitor transmission of a random access message from a wireless communication device, and transfer (to the D-MIMO system) of radio access responsibility for subsequent communication with the wireless communication device.

A ninth aspect is a network node comprising the apparatus of the eighth aspect.

A tenth aspect is an apparatus for a control unit (CU) of a distributed multiple-input multiple-output (D-MIMO) system configured for operation within a communication network, wherein the communication network comprises a radio access node and the D-MIMO system. The apparatus comprises controlling circuitry configured to cause configuration of a first set of access points (APs) of the D-MIMO system to monitor transmission of a random access message from a wireless communication device, reception of respective monitor reports from the first set of APs, selection of a second set of APs of the D-MIMO system based on the monitor reports, configuration of the second set of APs for subsequent communication with the wireless communication device, and takeover of radio access responsibility for subsequent communication with the wireless communication device.

An eleventh aspect is a control unit (CU) for a distributed multiple-input multiple-output (D-MIMO) system comprising the apparatus of the tenth aspect.

A twelfth aspect is an apparatus for an access point (AP) of a distributed multiple-input multiple-output (D-MIMO) system configured for operation within a communication network, wherein the communication network comprises a radio access node and the D-MIMO system. The apparatus comprises controlling circuitry configured to cause reception (from a control unit, CU, of the D-MIMO system) of a configuration to monitor a random access message from a wireless communication device, monitoring of the random access message from the wireless communication device, transmission of a monitor report to the CU, and reception (from the CU) of a configuration for subsequent communication with the wireless communication device, wherein the subsequent communication comprises transmission (to the wireless communication device) of a reply to the random access message in a reply resource associated with a random access message resource in which the random access message was received during the monitoring.

A thirteenth aspect is an access point (AP) for a distributed multiple-input multiple-output (D-MIMO) system comprising the apparatus of the twelfth aspect.

A fourteenth aspect is a distributed multiple-input multiple-output (D-MIMO) system comprising the control unit (CU) of the eleventh aspect and a plurality of access points (APs) according to the thirteenth aspect.

A fifteenth aspect is a radio access system configured for operation within a communication network, wherein the radio access system comprises the network node of the ninth aspect and the distributed multiple-input multiple-output (D-MIMO) system of the fourteenth aspect.

In some embodiments, any of the above aspects may additionally have features identical with or corresponding to any of the various features as explained above for any of the other aspects.

An advantage of some embodiments is that alternative approaches are provided for initial access in relation to a D-MIMO system.

An advantage of some embodiments is that co-existence between cellular communication and D-MIMO is facilitated and/or improved.

An advantage of some embodiments is that the signaling overhead (e.g., including system information broadcast) needed to enable initial access in relation to a D-MIMO system is reduced compared to other solutions for D-MIMO initial access.

An advantage of some embodiments is that the signaling overhead (e.g., including system information broadcast) needed to enable initial access in relation to a D-MIMO system is similar to the signaling overhead needed to enable initial access in relation to the cellular communication system.

An advantage of some embodiments is that the energy consumption (of the D-MIMO system and/or the wireless communication device) associated with initial access is reduced compared to other solutions for D-MIMO initial access.

An advantage of some embodiments is that a wireless communication device may be enabled to conveniently and/or efficiently access a D-MIMO system (which potentially provides better service than the radio access node).

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a signaling diagram illustrating signaling of an example random access protocol according to some embodiments;

FIG. 2 is a collection of schematic drawings illustrating example operation of a radio access system and a UE according to some embodiments;

FIG. 3 is a flowchart illustrating example method steps for a wireless communication device according to some embodiments;

FIG. 4 is a flowchart illustrating example method steps for a radio access node according to some embodiments;

FIG. 5 is a flowchart illustrating example method steps for a D-MIMO CU according to some embodiments;

FIG. 6 is a flowchart illustrating example method steps for a D-MIMO AP according to some embodiments;

FIG. 7 is a signaling diagram illustrating example signaling among a network node, a D-MIMO system, and a UE according to some embodiments;

FIG. 8 is a signaling diagram illustrating example signaling among a network node, a D-MIMO system, and a UE according to some embodiments;

FIG. 9 is a collection of schematic drawings illustrating example operation of a radio access system and a UE according to some embodiments;

FIG. 10 is a schematic block diagram illustrating an example apparatus for a wireless communication device according to some embodiments;

FIG. 11 is a schematic block diagram illustrating an example apparatus for a network node according to some embodiments;

FIG. 12 is a schematic block diagram illustrating an example apparatus for a D-MIMO CU according to some embodiments;

FIG. 13 is a schematic block diagram illustrating an example apparatus for a D-MIMO AP according to some embodiments;

FIG. 14 is a schematic drawing illustrating an example computer readable medium according to some embodiments;

FIG. 15 shows an example of a communication system 1500 in accordance with some embodiments;

FIG. 16 shows a UE 1600 in accordance with some embodiments;

FIG. 17 shows a network node 1700 in accordance with some embodiments;

FIG. 18 is a block diagram of a host 1800, which may be an embodiment of the host 1516 of FIG. 15, in accordance with various aspects described herein; and FIG. 19 shows a communication diagram of a host 1902 communicating via a network node 1904 with a UE 1906 over a partially wireless connection in accordance with some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

When a wireless communication device is referred to herein, any suitable wireless communication device is meant to be encompassed (e.g., a user equipment, UE, as defined for Third Generation Partnership Project, 3GPP, standardization). Similarly, when the term “UE” is used herein, it is meant as an example, and may be generalized to any suitable wireless communication device.

When a network node is referred to herein, any suitable network node is meant to be encompassed. For example, a network node may refer to a radio access node (e.g., a base station, a gNB as defined for 3GPP standardization, or a radio unit—RU or O-RU as defined for 3GPP standardization), a central network node (e.g., a network server, a central unit—CU or O-CU as defined for 3GPP standardization, a distributed unit—DU or O-DU as defined for 3GPP standardization), or a server node for distributed execution (e.g., a cloud server).

When a D-MIMO system is referred to herein, it is meant to encompass any suitable D-MIMO system comprising a control node (CU, a.k.a., D-MIMO central processing unit-CPU) and a plurality of access points (APs). Communication between the CU and each of the APs may be wired or wireless.

When a beam is referred to herein, it is meant to encompass any suitable, directionally varying, emission/reception pattern.

It should be noted that, even if terminology is used herein relating to 3GPP fifth generation (5G) standardization (e.g., terminology relating to new radio—NR), the described approaches may be equally applicable to other scenarios (e.g., future 3GPP standardization) where different terminology is applied for the corresponding functions.

Distributed multiple-input multiple-output (D-MIMO; a.k.a., “cell-free massive MIMO”, “user-centric MIMO”, etc.) is a well-known concept. A typical D-MIMO architecture comprises multiple APs that are interconnected and configured to cooperate phase-coherently when transmitting data to a UE. Each AP may comprise multiple antenna elements that are also configured to operate phase-coherently together. Thus, the APs together effectively form a large, coherently operating, antenna array.

Generally, D-MIMO may be used to improve communication links (e.g., in terms of one or more of: spectral efficiency, coverage, reliability, etc.). However, while D-MIMO may be very suitable to improve properties of communication links, there are challenges resulting from the geographical distribution of APs. One such problem related to how a suitable set of beams covering the cell area should be designed for system information signaling. When the term “system information signaling” is used herein, it is meant to encompass any signaling (e.g., broadcasting) of information needed for initial access. For example, the system information signaling may comprise synchronization block (SB) broadcast and/or initial access and system information (SI) broadcast.

One solution to this problem is to assign one synchronization signal block (SSB) beam for each beam of each AP, which leads to a signaling overhead that scales with the number of APs and the number of beams per AP. Other solutions to this problem might include using only a sub-set of the APs and/or a reduced number of beams per AP for initial access and SI broadcast, which somewhat reduces the signaling overhead (possibly at the cost of reduced broadcast performance). However, the signaling overhead would still depend on (e.g., be proportional to) the number of APs and/or the number of beams per AP.

In the following, approaches will be described and exemplified for initial access of a wireless communication device in relation to a D-MIMO system comprised in a communication network. According to the approaches, the initial access is assisted by the communication network via a radio access node of the communication network. The radio access node may be any suitable radio access node (e.g., a node providing cell coverage; such as a macro node, a micro node, etc.).

The coverage of the D-MIMO system is—partially or fully—overlapped by the coverage of the radio access node. For example, a set of APs (e.g., in the form of service antenna panels and respective radio units) may be distributed geographically in a specific part of a cell provided by the radio access node. The specific part of the cell may be a geographical area that requires a capacity and/or reliability boost (e.g., a crowded area such as a public square or a stadium).

The assistance comprises that a first portion of the signaling associated with initial access is handled by the radio access node, while a second portion of the signaling associated with initial access is handled by the D-MIMO system. At least, the system information signaling is handled by the radio access node, which provides a beneficial solution to the above-identified problem of signaling overhead caused by system information D-MIMO.

Thus, it is proposed that the initial access process is started in relation to a radio access node of the communication network, and is taken over by the D-MIMO system at a suitable time. The takeover by the D-MIMO system is typically transparent to the wireless communication device.

The network-assisted D-MIMO initial access may be implemented by using a modified version of a legacy framework for initial access and associated signaling. According to some embodiments, the initial access in relation to the D-MIMO system is executed by using signaling resources which are specified as random access resources for the radio access node of the assisting communication network.

An advantage of some embodiments is that alternative approaches are provided for initial access in relation to a D-MIMO system.

An advantage of some embodiments is that co-existence between cellular communication and D-MIMO is facilitated and/or improved.

An advantage of some embodiments is that the signaling overhead (e.g., including system information broadcast) needed to enable initial access in relation to a D-MIMO system is reduced compared to other solutions for D-MIMO initial access.

An advantage of some embodiments is that the signaling overhead (e.g., including system information broadcast) needed to enable initial access in relation to a D-MIMO system is similar to the signaling overhead needed to enable initial access in relation to the cellular communication system.

In some embodiments, no additional signaling overhead is required to find a suitable AP during initial access, compared to the signaling overhead needed for random access towards a radio access node of the communication network.

In some embodiments, where the wireless communication device is configured to transmit a random access message in two or more directions to find a suitable AP during initial access, only a relatively small amount of additional signaling overhead is required (proportional to the number of directions), compared to the signaling overhead needed for random access towards a radio access node of the communication network. An advantage of some embodiments is that the energy consumption (of the D-MIMO system and/or the wireless communication device) associated with initial access is reduced compared to other solutions for D-MIMO initial access.

An advantage of some embodiments is that a wireless communication device may be enabled to conveniently and/or efficiently access a D-MIMO system (which potentially provides better service than the radio access node).

Thus, the wireless communication device is enabled to efficiently (e.g., in relation to signaling overhead and/or energy consumption) connect to the D-MIMO system. According to some embodiments, the wireless communication device is also enabled to find—during the random access procedure—at least one suitable direction for subsequent communication (transmission and/or reception) via the D-MIMO system; e.g., direction(s) towards one or more AP(s) of the D-MIMO system. Alternatively or additionally, the D-MIMO system is enabled to find—during the random access procedure—at least one suitable AP (and possibly an associated suitable direction) for subsequent communication (transmission and/or reception) with the wireless communication device, according to some embodiments.

Generally, the initial access will be referred to herein in the form of a random access (RA) protocol. It should be noted that any suitable initial access approach is intended to be encompassed within such terminology, even if not explicitly termed as a random access protocol.

Furthermore, a random access protocol with four messages will be used as illustration, and exemplifying terminology relating to 3GPP 5G standardization will be used. It should be understood that this is not intended as limiting, and that the described approaches may be equally applicable to any suitable random access protocol; regardless of terminology. For example, a suitable random access protocol may have more, or less, than four messages, if only it has the message(s) required for the applicable embodiment.

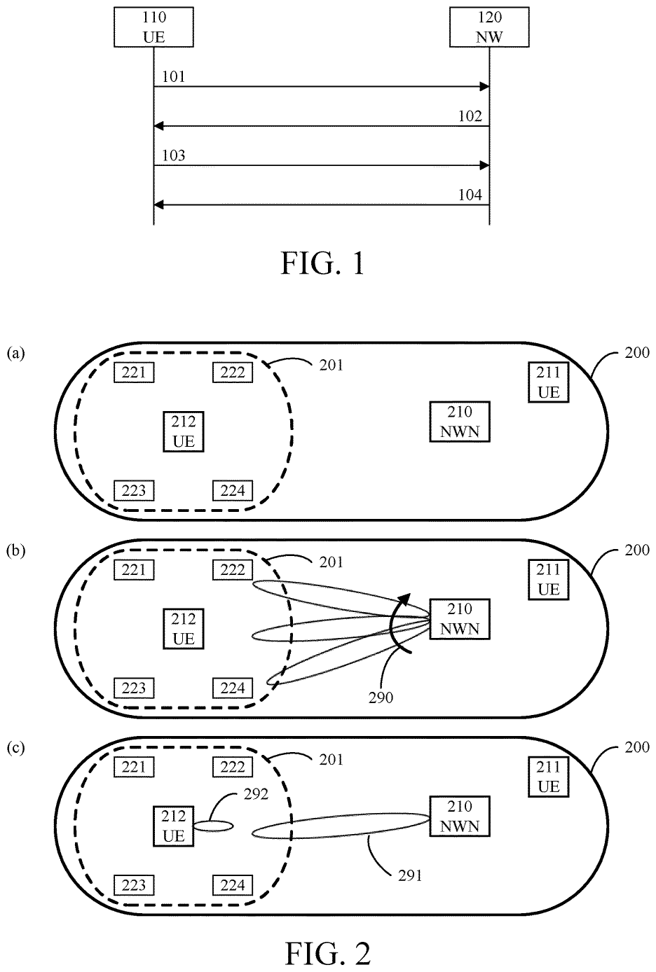

FIG. 1 illustrates signaling of an example random access protocol with four messages according to some embodiments. The signaling relates to initial access for a UE 110 in relation to a network (NW) 120.

The example random access protocol comprises a first random access protocol message 101 which is transmitted from the UE to the NW, a second random access protocol message 102 which is transmitted from the NW to the UE, a third random access protocol message 103 which is transmitted from the UE to the NW, and a fourth random access protocol message 104 which is transmitted from the NW to the UE. The first random access protocol message 101 may be a random access preamble (e.g., a physical random access channel—PRACH—preamble), the second random access protocol message 102 may be a random access response (RAR; e.g., conveyed using a physical downlink control channel and/or a physical downlink shared channel—PDCCH/PDSCH), the third random access protocol message 103 may be a contention resolution message (e.g., conveyed using a physical uplink shared channel—PUSCH), and the fourth random access protocol message 104 may be a connection set-up message (e.g., conveyed using PDCCH/PDSCH).

In some contexts, the first, second, third, and fourth random access protocol messages 101, 102, 103, 104 are referred to as msg1, msg2, msg3, and msg4, respectively.

Generally, the functionality of each of the messages may be multifold. Typically, the RA preamble initiates the RA procedure and provides means of estimating the propagation delay between the UE and a relevant radio access node of the NW, and the RA response confirms reception of the RA preamble and provides a time-alignment configuration. The contention resolution message and the connection set-up message are used to resolve potential collisions that might arise due to random access, and for transferring the UE to connected state in relation to the relevant radio access node.

A preliminary step (not shown) of the initial access procedure may comprise network broadcast of system information (e.g., periodical broadcast of the synchronization block—SB), which—when detected by the UE—may be used for synchronization (e.g., timing and frequency synchronization) and decoding of some of the system information.

Within one SB transmission period, the SB may be repeatedly transmitted in different directions using beamforming, which improves the link budget and detection performance. The maximum number of SB repetitions within one transmission period in NR is 4 or 8 for FR1 and 64 for FR2. In practice, this often implies that the SB is beamformed in a maximum of 4 or 8 different directions in FR1 and in a maximum of 64 different directions in FR2.

The initial access procedure is typically performed when the UE joins a new cell, or switches from idle mode to connected mode.

The random access protocol illustrated in FIG. 1 may be seen as implementing 4-step contention-based random access according to 3GPP 5G.

The terminology of a first, second, third, and fourth random access protocol messages is used herein. Typically, but not necessarily, the numbering refers to an order in which the random access protocol messages are conveyed, while it should be noted that there may possibly be one or more additional messages between any adjacently numbered messages in the random access protocol. It should also be noted that, in some embodiments, all four random access protocol messages are not necessarily present. For example, some embodiments may include only two random access protocol messages, one implementing the function of the first message and another implementing the functions of the second and fourth messages.

The first random access protocol message may be defined as a message transmitted from the UE to the NW for requesting initial access. The second random access protocol message may be defined as a message transmitted from the NW to the UE for acknowledging reception of the request for initial access. The third random access protocol message may be defined as a message transmitted from the UE to the NW for collision management. The fourth random access protocol message may be defined as a message transmitted from the NW to the UE for transferring the UE to a connected mode.

FIG. 2 schematically illustrates example operation of a radio access system and a UE according to some embodiments. The radio access system comprises a radio access node of a communication network (depicted as a network node, NWN, 210) and a D-MIMO system. The D-MIMO system comprises a plurality of APs 221, 222, 223, 224 and a CU (not shown). The NWN 210 has a coverage area 200 and the D-MIMO system has a coverage area 201. In this example, the coverage area 201 of the D-MIMO system is fully overlapped by the coverage area 200 of the radio access node.

Part (a) of FIG. 2 illustrates the radio access system scenario, as well as two UEs 211, 212. The UE 212 is within the coverage area 200 of the NWN 210 as well as within the coverage area 201 of the D-MIMO system, while the UE 211 is within the coverage area 200 of the NWN 210 but not within the coverage area 201 of the D-MIMO system. Thus, the UE 212 may be served by the NWN 210 or via the D-MIMO system, while the UE 211 cannot be served via the D-MIMO system.

Part (b) of FIG. 2 illustrates system information signaling 290 by the NWN 210, wherein the system information signaling may comprise transmission/broadcast of a plurality of beams (e.g., SSB beams with respective synchronization block, SB1, SB2, SB3, etc.). By listening to the system information signaling 290, the UEs 211, 212 can determine which UE beam is most suitable to use for transmission/reception in relation to the NWN 210. As explained earlier, system information signaling may be seen as a preparation for initial access, and utilizing system information signaling from the NWN 210 as a preparation for initial access towards the D-MIMO system may be beneficial in terms of signaling overhead.

Part (c) of FIG. 2 illustrates transmission of a random access preamble by UE 212. The random access preamble is transmitted using a beam 292 directed towards the NWN 210, which was determined by the UE 212 to be most suitable to use in relation to the NWN 210. The NWN 210 detects the random access preamble via a corresponding reception beam 291, and can estimate a direction towards the UE 212 based on the reception beam 291 where the random access preamble was detected. In the example of FIG. 2, the estimated direction from the NWN 210 towards the UE 212 indicates that the UE 212 might be within the coverage area 201 of the D-MIMO system, and the NWN 210 could attempt radio access via the D-MIMO system for the UE 212 (e.g., to offload the NWN 210). Similarly, the NWN could deduce from a random access preamble transmitted from the UE 211 that the UE 211 is most probably not within the coverage area 201 of the D-MIMO system, and that radio access via the D-MIMO system should not be attempted for the UE 211.

Thus, a first portion of the signaling associated with initial access for UE 212 is handled by the NWW 210. In the following, transfer of responsibility from the NWN 210 to the D-MIMO system (such that a second portion of the signaling associated with initial access is handled by the D-MIMO system) will be exemplified.

As will be seen in the following exemplifications, there are variants of the random access preamble transmission by UE 212 and corresponding detection by NWN 201 (compare with part (c) of FIG. 2). For example, the transmission of the random access preamble by the UE 212 may be detected by an AP of the D-MIMO system (instead of, or in addition to, detection by the NWN 210). Listening to the random access preamble may enable the D-MIMO system to determine whether the UE 212 is within the coverage area 201 of the D-MIMO system, and/or may enable the D-MIMO system to determine a suitable AP for communication with the UE 212. Alternatively or additionally, the UE 212 may transmit the random access preamble in two or more directions (instead of, or in addition to, using a beam 292 directed towards the NWN 210). Transmission of the random access preamble in two or more directions may enable the D-MIMO system to determine whether the UE 212 is within the coverage area 201 of the D-MIMO system, and/or may enable the D-MIMO system to determine a suitable AP for communication with the UE 212.

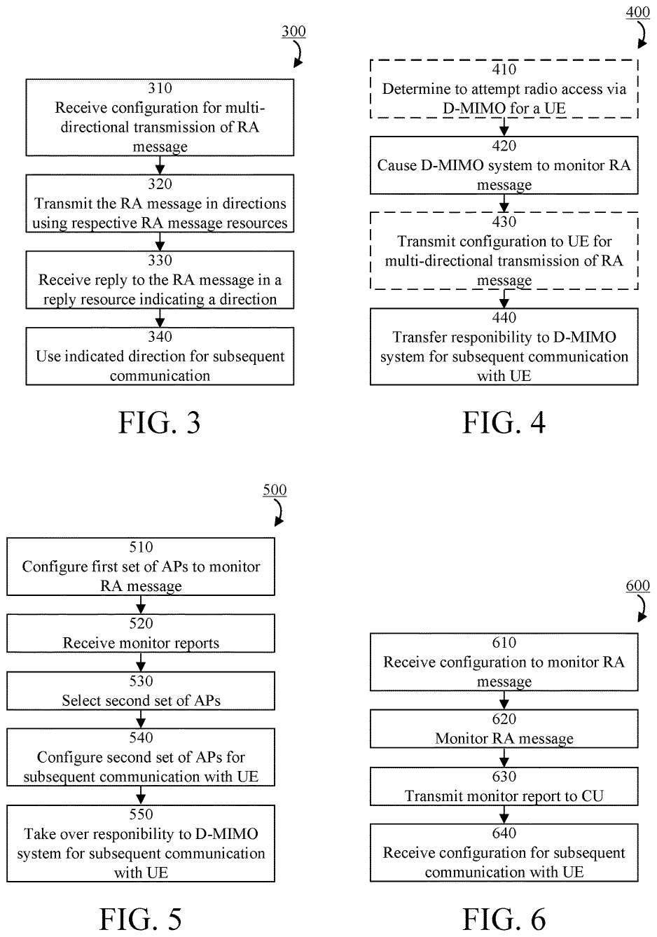

FIGS. 3-6 illustrate example methods for respective devices according to some embodiments. According to some embodiments, all of the methods of FIGS. 3-6 may be performed in association with each other for initial access of a wireless communication device in relation to a D-MIMO system which has overlapping coverage area with a radio access node of a communication network. Alternatively, only one, two, or three of the of the methods of FIGS. 3-6 may be performed in association for initial access of a wireless communication device in relation to a D-MIMO system which has overlapping coverage area with a radio access node of a communication network. For example, the method of FIG. 3 may be excluded as will be exemplified later herein.

FIG. 3 illustrates an example method 300 for a wireless communication device configured for operation in association with a communication network, wherein the communication network comprises a radio access node and a D-MIMO system.

A configuration for multi-directional transmission of a random access message is received from the radio access node, as illustrated by step 310.

The random access message is transmitted in two or more directions, as illustrated by step 320. The transmission uses a respective random access message resource for each direction.

A reply to the random access message is received from an access point of the D-MIMO system, as illustrated by step 330. The reply is received in a reply resource which indicates one of the two or more directions by being associated with one of the respective random access message resources.

The indicated direction is used for subsequent communication via the D-MIMO system, as illustrated by step 340.

Generally, a resource (e.g., a random access message resource, a reply resource, etc.) may be any suitable communication resource. For example, a communication resource may be defined by one or more of: a time resource (e.g., a time window with specified starting time and duration), a frequency resource (e.g., a frequency interval with specified center frequency and bandwidth), a spatial resource (e.g., a beam with a specified direction), etc.

A reply resource may indicate one of the two or more directions by being associated with one of the respective random access message resources in any suitable way.

For example, the random access message may be transmitted in two or more directions using respectively corresponding two or more time resources (i.e., random access message resources). Then, there may be corresponding two or more time resources defined as reply resources, where each reply resource is associated with one of the random access message resources (and each random access message resource is associated with one of the reply resources). For example, the association between reply resources and random access message resources may be manifested by the order in which they appear in time (e.g., the first-appearing reply resource is associated with the first-appearing random access message resource, and so on). Corresponding examples are applicable to other types of resources.

Thus, when a reply message is received in a particular reply resource, there is an association to a corresponding particular random access message resource, and the wireless device can determine the indicated direction as the direction that was transmitted using the particular random access message resource.

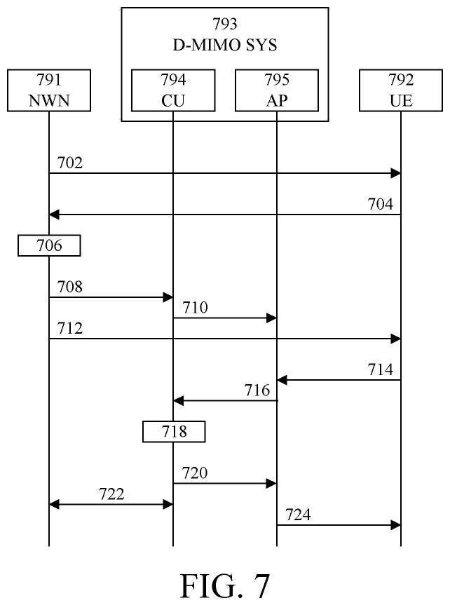

In some embodiments (compare with FIG. 7), the configuration for multi-directional transmission of the random access message (step 310) may be comprised in a second random access protocol message (compare with 102 of FIG. 1); a.k.a., a message transmitted from the radio access node for acknowledging reception of an earlier-transmitted request for initial access.

Thus, although not shown in FIG. 3, the wireless communication device may—before step 310—receive system information signaling transmitted by the radio access node, and transmit a first random access protocol message (compare with 101 of FIG. 1); a.k.a., a message transmitted from the wireless communication device (to the radio access node and/or to the D-MIMO system) for requesting initial access. The second random access protocol message may be received in response to transmission of the first random access protocol message.

In these embodiments (compare with FIG. 7), the random access message (step 320) may be a third random access protocol message (compare with 103 of FIG. 1); a.k.a., a message transmitted from the wireless communication device (to the radio access node and/or to the D-MIMO system) for collision management.

In these embodiments (compare with FIG. 7), the reply to the random access message (step 330) may be a fourth random access protocol message (compare with 104 of FIG. 1); a.k.a., a message transmitted from the D-MIMO system for transferring the wireless communication device to a connected mode.

In these embodiments (compare with FIG. 7), the subsequent communication (step 340) may comprise any suitable communication (e.g., data transfer).

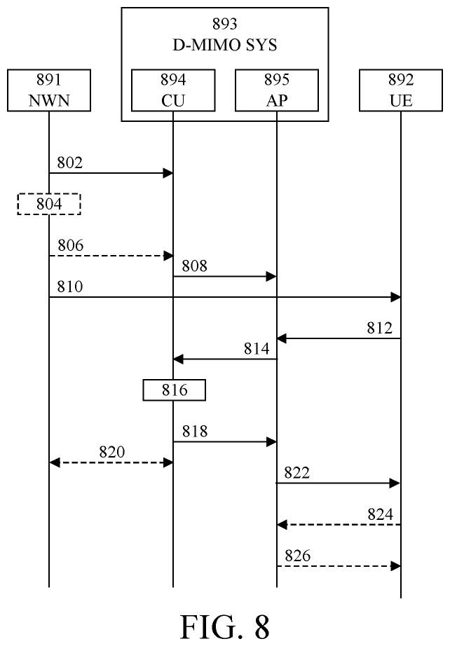

In some embodiments (compare with FIG. 8), the configuration for multi-directional transmission of the random access message (step 310) may be comprised in a system information signaling transmitted by the radio access node.

In these embodiments (compare with FIG. 8), the random access message (step 320) may be a first random access protocol message (compare with 101 of FIG. 1); a.k.a., a message transmitted from the wireless communication device (to the radio access node and/or to the D-MIMO system) for requesting initial access.

In these embodiments (compare with FIG. 8), the reply to the random access message (step 330) may be a second random access protocol message (compare with 102 of FIG. 1); a.k.a., a message transmitted from the D-MIMO system for acknowledging reception of the request for initial access.

In these embodiments (compare with FIG. 8), the subsequent communication (step 340) may comprise any suitable communication (e.g., data transfer), as well as transmission of a third random access protocol message (compare with 103 of FIG. 1); a.k.a., a message transmitted from the wireless communication device to the D-MIMO system for collision management, and/or a fourth random access protocol message (compare with 104 of FIG. 1); a.k.a., a message transmitted from the D-MIMO system for transferring the wireless communication device to a connected mode.

FIG. 4 illustrates an example method 400 for a radio access node configured for operation within a communication network, wherein the communication network comprises the radio access node and a D-MIMO system.

As illustrated by step 420, the D-MIMO system is caused to monitor transmission of a random access message from a wireless communication device. The causing may be for a specific wireless communication device, or may relate to two or more (e.g., all relevant) wireless communication devices.

Subsequently, radio access responsibility for subsequent communication with the wireless communication device is transferring to the D-MIMO system, as illustrated by step 440.

Typically, the radio access node continues to take radio access responsibility for communication with the wireless communication device until the transfer is complete. It should be noted that there may be situations where the execution of step 420 does not result in a transfer of the radio access responsibility to the D-MIMO system (e.g., when no D-MIMO AP can receive transmissions from the wireless communication device because the wireless communication device is not within the coverage of the D-MIMO system).

Transferring radio access responsibility for subsequent communication with the wireless communication device to the D-MIMO system may be accomplished in any suitable way. For example, a responsibility transfer protocol may be executed between the radio access node (or another network node of the communication network) and the D-MIMO CU. The transfer protocol may be executed using wireless signaling and/or wired (e.g., backhaul) signaling.

Typically, the transfer protocol includes a transfer request message (e.g., from the CU, indicating that the D-MIMO system is ready to take over responsibility) and a transfer acknowledgement message (e.g., from the network node, indicating that the radio access node will seize responsibility). For example, the D-MIMO system may be ready to take over responsibility when one or more D-MIMO AP(s) received a random access message from the wireless communication device (compare with step 320 of FIG. 3); e.g., with sufficient quality of reception, and/or when a set of D-MIMO APs have been configured for subsequent communication with the wireless communication device.

Generally, quality of reception is meant to encompass any suitable quality metric (e.g., signal strength, signal-to-interference ratio—SIR, reference signal received power—RSRP, reference signal received quality—RSRQ, or similar).

In some embodiments, the transfer of radio access responsibility to the D-MIMO system is implicit. For example, the causing of step 420 may imply that the network expects the D-MIMO system to take over radio access responsibility.

As illustrated by optional step 410, step 420 may be preceded by a determination to attempt radio access via the D-MIMO system for the wireless communication device, and step 420 may be performed responsive to the determination. The determination to attempt radio access via the D-MIMO system for the wireless communication device may be based on any suitable information.

For example, the determination to attempt radio access via the D-MIMO system may be responsive to a traffic load of the radio access node exceeding a load threshold (i.e., the radio access node may try offloading via use of the D-MIMO system). In this case, the determination may be for randomly selected wireless communication devices, or for wireless communication devices which are likely to be within the coverage area of the D-MIMO system, for example.

Alternatively or additionally, the determination to attempt radio access via the D-MIMO system may be responsive to a location indication for the wireless communication device falling within the coverage area of the D-MIMO system. The location indication may take any suitable form (e.g., a direction, a geographical location, etc.). Further, the location indication may be achieved in any suitable way (e.g., as exemplified in FIG. 2, based on a location of a neighboring cell that the wireless communication device is handed over from, in the form of a most recent location information available for the wireless communication device such as a location for a previous connection of the wireless communication device, etc.).

In embodiments where step 410 is excluded, step 420 may be performed in relation to all, or some, wireless communication devices within the coverage of the radio access node. For example, step 420 may be performed in relation to some randomly selected wireless communication devices, or in relation to wireless communication devices with the capability to transmit a random access message in two or more directions and interpret the corresponding response (compare with FIG. 3).

As illustrated by optional step 430, the method 400 may further comprise transmitting a configuration for multi-directional transmission of the random access message to the wireless communication device (compare with step 310 of FIG. 3). For example, step 430 may be performed responsive to the determination of step 410, or responsive to the causing of step 420. Generally, step 430 may be performed before, after, or in parallel to step 420.

Causing the D-MIMO system to monitor transmission of a random access message from a wireless communication device may be accomplished in any suitable way (e.g., by instruction, triggering, configuring, or similar). For example, the causing of step 420 may be executed by signaling between the radio access node (or another network node of the communication network) and the D-MIMO CU. This signaling may be executed using wireless signaling and/or wired (e.g., backhaul) signaling. In some embodiments, the causing of step 420 is implicit. For example, the D-MIMO system may be configured to always monitor transmission of a random access message from a wireless communication device

In some embodiments (compare with FIGS. 7 and 8), causing the D-MIMO system to monitor transmission of the random access message (step 420) comprises one or more of: transmitting a monitor request message to the D-MIMO system, providing random access resource information to the D-MIMO system, and transmitting a monitor trigger message to the D-MIMO system.

In some embodiments (compare with FIG. 7), the random access message, which the D-MIMO system is configured to monitor (step 420) and which the wireless communication device may be configured to transmit multi-directionally (step 430), is a third random access protocol message (compare with 103 of FIG. 1); a.k.a., a message transmitted from the wireless communication device for collision management.

In these embodiments (compare with FIG. 7), the configuration for multi-directional transmission of the random access message (step 430) may be comprised in a second random access protocol message (compare with 102 of FIG. 1); a.k.a., a message transmitted from the radio access node for acknowledging reception of an earlier-transmitted request for initial access.

Thus, although not shown in FIG. 4, the radio access node may—before step 430—transmit system information signaling, and receive a first random access protocol message (compare with 101 of FIG. 1); a.k.a., a message transmitted from the wireless communication device for requesting initial access. The second random access protocol message may be transmitted in response to reception of the first random access protocol message.

In these embodiments (compare with FIG. 7), a reply to the random access message may be a fourth random access protocol message (compare with 104 of FIG. 1); a.k.a., a message transmitted for transferring the wireless communication device to a connected mode. When the transfer (step 440) is successful, transmission of the reply to the random access message, as well as subsequent communication with the wireless communication device, is handled by the D-MIMO system.

In some embodiments (compare with FIG. 8), the random access message, which the D-MIMO system is configured to monitor (step 420) and which the wireless communication device may be configured to transmit multi-directionally (step 430), is a first random access protocol message (compare with 101 of FIG. 1); a.k.a., a message transmitted from the wireless communication device for requesting initial access.

In these embodiments (compare with FIG. 8), the configuration for multi-directional transmission of the random access message (step 430) may be comprised in a system information signaling transmitted by the radio access node.

In these embodiments (compare with FIG. 8), a reply to the random access message may be a second random access protocol message (compare with 102 of FIG. 1); a.k.a., a message transmitted for acknowledging reception of the request for initial access. When the transfer (step 440) is successful, transmission of the reply to the random access message, as well as subsequent communication with the wireless communication device—e.g., including a third random access protocol message (compare with 103 of FIG. 1) and/or a fourth random access protocol message (compare with 104 of FIG. 1)—is handled by the D-MIMO system.

FIG. 5 illustrates an example method 500 for a control unit (CU) of a D-MIMO system configured for operation within a communication network, wherein the communication network comprises a radio access node and the D-MIMO system.

As illustrated by step 510, a first set of access points (APs) of the D-MIMO system is configured to monitor transmission (compare with step 320 of FIG. 3) of a random access message from a wireless communication device. The configuration may be performed via the internal signaling network (wired or wireless) of the D-MIMO system.

Execution of step 510 is typically caused by the radio access node or another network node (compare with step 420 of FIG. 4). In some embodiments (compare with FIGS. 7 and 8), step 510 is performed in response to receiving—from the radio access node or another network node—one or more of: a monitor request message, random access resource information, and a monitor trigger message.

The configuration of each AP in step 510 typically includes information (e.g., as provided by from the network in step 420 of FIG. 4) regarding which resource(s) should be monitored.

The first set of APs may comprise all APs of the D-MIMO system, or a sub-set thereof. For example, the sub-set may be based on a probable location of the wireless communication device (such that APs that are not likely to be close to the wireless communication device are excluded from the first set). Alternatively or additionally, the sub-set may comprise some distributed (e.g., evenly, randomly, etc.) APs among the APs of the D-MIMO system.

As illustrated by step 520, respective monitor reports are received from the first set of APs. The reports may be received via the internal signaling network (wired or wireless) of the D-MIMO system. Typically, each monitor reports indicates whether the corresponding AP has detected the random access message. Further information may also be included, such as a quality of reception for the random access message, quality of reception for each of two or more AP beams, a selected beam for the AP, an indication of direction between the AP and the wireless communication device, information regarding the resource where the random access message was received, etc.

Generally, the monitor reports may comprise one or more of: raw information corresponding to reception of the random access message (e.g., simply forwarding the received signal), a partly or fully decoded random access message, and metadata derived from reception of the random access message (e.g., further information as exemplified above).

Based on the monitor reports, the CU selects a second set of APs of the D-MIMO system, as illustrated by step 530.

The second set of APs may comprise all APs of the first set, or a sub-set thereof. For example, the sub-set may be based on a quality of reception for the random access message (e.g., selecting AP(s) with best quality of reception, or with quality of reception above some threshold value).

Alternatively or additionally, the second set of APs may comprise APs that are not comprised in the first set. For example, when some evenly distributed APs were included in the first set, the second set may include the AP(s) from the first set with best quality of reception, as well as some neighboring APs that were not included in the first set.

A possible beam selection for each AP of the second set may be performed by the relevant AP itself, or by the CU based on the monitor reports.

As illustrated by step 540, APs of the second set of APs are configured for subsequent communication with the wireless communication device. The configuration may be performed via the internal signaling network (wired or wireless) of the D-MIMO system.

As illustrated by step 550, the D-MIMO system takes over radio access responsibility for subsequent communication with the wireless communication device (compare with step 440 of FIG. 4), e.g., in response to the configuration of the second set of APs in step 540. Generally, step 550 may be performed at any suitable point in time after (or in parallel with) execution of step 510.

In some embodiments (compare with FIG. 7), the random access message, which the APs of the first set are configured to monitor (step 510), is a third random access protocol message (compare with 103 of FIG. 1); a.k.a., a message transmitted from the wireless communication device for collision management.

In some embodiments (compare with FIG. 8), the random access message, which the APs of the first set are configured to monitor (step 510), is a first random access protocol message (compare with 101 of FIG. 1); a.k.a., a message transmitted from the wireless communication device for requesting initial access.

FIG. 6 illustrates an example method 600 for an access point (AP) of a D-MIMO system configured for operation within a communication network, wherein the communication network comprises a radio access node and the D-MIMO system.

As illustrated by step 610, a configuration is received from the D-MIMO CU to monitor a random access message from a wireless communication device (compare with step 510 of FIG. 5).

The random access message from the wireless communication device is monitored, as illustrated by step 620, and a monitor report is transmitted to the CU (compare with step 520 of FIG. 5), as illustrated by step 630.

As illustrated by step 640, a configuration is receiving from the CU (compare with step 540 of FIG. 5), for subsequent communication with the wireless communication device. The subsequent communication comprises transmitting, to the wireless communication device, a reply to the random access message (compare with step 330 of FIG. 3).

The reply is transmitted in a reply resource associated with a random access message resource in which the random access message was received during the monitoring. Thereby, the reply resource may indicate one of the two or more directions which the wireless communication device used for transmission of the random access message, as elaborated on in connection with FIG. 3.

In some embodiments (compare with FIG. 7), the random access message, which the AP is configured to monitor (steps 610, 620), is a third random access protocol message (compare with 103 of FIG. 1); a.k.a., a message transmitted from the wireless communication device for collision management.

In these embodiments (compare with FIG. 7), the reply to the random access message (step 640) may be a fourth random access protocol message (compare with 104 of FIG. 1); a.k.a., a message transmitted from the D-MIMO system for transferring the wireless communication device to a connected mode.

In these embodiments (compare with FIG. 7), the subsequent communication (step 640) may comprise any suitable communication (e.g., data transfer).

In some embodiments (compare with FIG. 8), the random access message, which the AP is configured to monitor (steps 610, 620), is a first random access protocol message (compare with 101 of FIG. 1); a.k.a., a message transmitted from the wireless communication device for requesting initial access.

In these embodiments (compare with FIG. 8), the reply to the random access message (step 640) may be a second random access protocol message (compare with 102 of FIG. 1); a.k.a., a message transmitted from the D-MIMO system for acknowledging reception of the request for initial access.

In these embodiments (compare with FIG. 8), the subsequent communication (step 640) may comprise any suitable communication (e.g., data transfer), as well as transmission of a third random access protocol message (compare with 103 of FIG. 1); a.k.a., a message transmitted from the wireless communication device to the D-MIMO system for collision management, and/or a fourth random access protocol message (compare with 104 of FIG. 1); a.k.a., a message transmitted from the D-MIMO system for transferring the wireless communication device to a connected mode.

FIG. 7 illustrates example signaling among a network node (NWN) 791, a UE 792, and a D-MIMO system (D-MIMO SYS) 793 comprising a CU 794 and an AP 795 among a plurality of APs.

The NWN 791 (e.g., in the form of a radio access node) transmits system information signaling 702, which may be used by the UE 792 as described earlier (compare with FIG. 2). Thereafter, when the UE 792 needs a connection, the UE 792 transmits a first random access protocol message 704 (compare with 101 of FIG. 1), which is detected by the NWN 791 (e.g., in the form of a radio access node).

The NWN 791 (e.g., in the form of a radio access node or another network node) determines 706 to attempt radio access via the D-MIMO system (compare with step 410 of FIG. 4), and transmits (e.g., in the form of a radio access node or another network node) a monitor request message 708 to the CU 794 (compare with step 420 of FIG. 4) to cause the D-MIMO system to monitor transmission of a third random access protocol message (compare with 103 of FIG. 1) from the UE 792. The CU 794 configures a first set of access points, including the AP 795, to monitor transmissions accordingly, as illustrated by 710 (compare with step 510 of FIG. 5, and with step 610 of FIG. 6).

The NWN 791 (e.g., in the form of a radio access node) transmits a second random access protocol message 712 to the UE 792 (compare with 102 of FIG. 1). The second random access protocol message 712 may, or may not, comprise a configuration for multi-directional transmission of the third random access protocol message (compare with step 430 of FIG. 4 and step 310 of FIG. 3).

The UE 792 transmits a third random access protocol message 714, possibly in two or more directions (compare with step 320 of FIG. 3). The AP 795 detects the third random access protocol message 714 during monitoring and sends a monitor report 716 to the CU 794 (compare with steps 620, 630 of FIG. 6, and with step 520 of FIG. 5).

Based on the monitor report 716 (and on any monitor report(s) from other AP(s)), the CU 794 selects a second set of APs, as illustrated by 718 (compare with step 530 of FIG. 5). In this example, the AP 795 belongs to the second set, and the CU 794 configures it for subsequent communication with the UE 792, as illustrated by 720 (compare with step 540 of FIG. 5, and with step 640 of FIG. 6).

The NWN 791 (e.g., in the form of a radio access node or another network node) transfers the radio access responsibility for subsequent communication with the UE 792 to the D-MIMO system 793, as illustrated by 722 (compare with step 440 of FIG. 4, and with step 550 of FIG. 5). The AP 795 transmits a fourth random access protocol message 724 (compare with 104 of FIG. 1) to the UE 792 (compare with step 330 of FIG. 3), which may be indicative of a direction to be used by the UE 792 for subsequent communication (compare with step 340 of FIG. 3).

### A Particular Example Relating to FIG. 7

A macro base station (BS) 791 broadcasts the synchronization block (SB), beamformed in different directions, as illustrated by 702. This action is done periodically to facilitate initial access in the macro BS coverage area. A UE 792 (residing within the coverage areas of both the D-MIMO system 793 and the macro BS) that has the intention of accessing the communication network performs detection of the synchronization block 702 and determine a preferred direction of reception/transmission from/to the BS.

The UE transmits a random access preamble (RA-P), beamformed in the preferred direction towards the macro BS, as illustrated by 704.

Based on analysis of the received RA-P (e.g., estimated propagation delay, angle of arrival, etc.), and on previous knowledge of propagation properties towards to D-MIMO coverage area, the macro BS infers whether or not the UE (likely) resides within the D-MIMO coverage area. Based on this inference, and on other criteria (e.g., need for offloading traffic to D-MIMO, availability of D-MIMO, etc.), the macro BS decides whether to offload the UE to the D-MIMO system, as illustrated by 706.

If the UE is to be offloaded to the D-MIMO system, the macro BS informs the D-MIMO CPU 794 that the UE initial access procedure will be completed by the D-MIMO system, as illustrated by 708. To this end, the macro BS sends a set of necessary configuration parameters to the D-MIMO CPU. These may include one or more of: parameters indicating UE-BS transmission timing correction (TTC), parameters indicating transmission timing correction between D-MIMO system and macro BS, information about the detected RA-P, scheduling configuration of the contention resolution message (msg3), scheduling configuration of the connection set-up message (msg4), etc.

Based on the information received in 708, the D-MIMO CPU configures the first set of D-MIMO APs 795 for reception of the contention resolution message (msg3), as illustrated by 710.

The macro BS sends the RA response to the UE, as illustrated by 712. The RA response may comprise one or more of: transmission timing correction (e.g., the calculated TTC needed for proper time alignment with the D-MIMO system, and not the UE-BS time alignment), a temporary identity needed for further communication with the D-MIMO system, transmission configuration of msg3 that may indicate that msg3 is to be transmitted repeatedly in time (e.g., the UE may be—implicitly or explicitly—configured to beamform msg3 transmissions in different directions), and reception configuration of msg4 (e.g., the UE may be—implicitly or explicitly—configured to beamform msg4 receptions towards different directions).

UE performs transmission of msg3 (e.g., beamformed towards the macro BS, or using multi-directional beamforming with different resources for different directions), as illustrated by 714.

The D-MIMO APs monitors reception of msg3, and information about the reception (e.g., received signal quality) is forwarded to the D-MIMO CPU, as illustrated by 716.

Based on the information about the reception (e.g., received signal quality) and other parameters (e.g., traffic load), the D-MIMO CPU can make a decision on whether or not to take over the communication with the UE from macro BS. If the D-MIMO system decides to take over, the D-MIMO CPU may send a request to the macro BS to transfer the UE, and the macro BS may respond with a grant message, as illustrated by 722. The grant message may comprise configuration parameters necessary for completing the transfer/takeover (e.g., configuration(s) of higher protocol layers).

In association with the transfer, the D-MIMO CPU selects suitable AP(s) for communication with the UE and configures the appropriate AP(s) for sending the connection set-up message (msg4), as illustrated by 718 and 720.

The selected AP(s) transmit msg4, as illustrated by 724. The content of msg4 may be identical to that of a legacy NR msg4, for example. The temporary identity of the UE may thereafter belong to the cell provided by the D-MIMO system (if defined as separate from the macro BS cell).

Generally, communication between the macro BS and the D-MIMO CPU can, in principle, take places using any type of link between the D-MIMO CPU and the macro BS (e.g., a proprietary link between the macro BS and the D-MIMO CPU, or a standardized interface link between the macro BS and the D-MIMO CPU).

FIG. 8 illustrates example signaling among a network node (NWN) 891, a UE 892, and a D-MIMO system (D-MIMO SYS) 893 comprising a CU 894 and an AP 895 among a plurality of APs.

The NWN 891 (e.g., in the form of a radio access node or another network node) provides random access resource information 802 to the D-MIMO system 893, determines 804 (e.g., in the form of a radio access node or another network node) to attempt radio access via the D-MIMO system (compare with step 410 of FIG. 4), and transmits (e.g., in the form of a radio access node or another network node) a monitor trigger message 806 to the CU 894 (compare with step 420 of FIG. 4) to cause the D-MIMO system to monitor transmission of a first random access protocol message (compare with 101 of FIG. 1) from the UE 892. The CU 894 configures a first set of access points, including the AP 895, to monitor transmissions accordingly, as illustrated by 808 (compare with step 510 of FIG. 5, and with step 610 of FIG. 6).

The NWN 891 (e.g., in the form of a radio access node) transmits system information signaling 810. The system information signaling 810 may, or may not, comprise a configuration for multi-directional transmission of the first random access protocol message (compare with step 430 of FIG. 4 and step 310 of FIG. 3).

Thereafter, when the UE 892 needs a connection, the UE 892 transmits a first random access protocol message 812, possibly in two or more directions (compare with step 320 of FIG. 3). The AP 895 detects the first random access protocol message 812 during monitoring and sends a monitor report 814 to the CU 894 (compare with steps 620, 630 of FIG. 6, and with step 520 of FIG. 5).

Based on the monitor report 814 (and on any monitor report(s) from other AP(s)), the CU 894 selects a second set of APs, as illustrated by 816 (compare with step 530 of FIG. 5). In this example, the AP 895 belongs to the second set, and the CU 894 configures it for subsequent communication with the UE 892, as illustrated by 818 (compare with step 540 of FIG. 5, and with step 640 of FIG. 6).

The NWN 891 (e.g., in the form of a radio access node or another network node) transfers the radio access responsibility for subsequent communication with the UE 892 to the D-MIMO system 893, as illustrated by 820 (compare with step 440 of FIG. 4, and with step 550 of FIG. 5).

The AP 895 transmits a second random access protocol message 822 (compare with 102 of FIG. 1) to the UE 892 (compare with step 330 of FIG. 3), which may be indicative of a direction to be used by the UE 892 for subsequent communication (compare with step 340 of FIG. 3). The UE 892 transmits a third random access protocol message 824 (compare with 103 of FIG. 1), and the AP 895 transmits a fourth random access protocol message 826 (compare with 104 of FIG. 1) to the UE 892.

### A Particular Example Relating to FIG. 8

A macro base station (BS) 891 broadcasts the synchronization block (SB), beamformed in different directions, as illustrated by 810. As part of the broadcast, the UE 892 (e.g., all UEs) is explicitly configured to beamform the RA preamble (msg1) in different directions in different RA occasions, and the configuration includes explicit linking of a set of RA occasions with a set of RA response occasions.

The macro BS shares the configuration of RA-P and RA response occasions with the D-MIMO CPU 894. The sharing can be performed explicitly by means of a dedicated message, as illustrated by 802, or implicitly by the D-MIMO system extracting the macro cell RA configuration from the system information 810 broadcast by the macro BS.

As illustrated by 808, the D-MIMO CPU configures the D-MIMO AP(s) 895 to receive/monitor the RA-P transmitted by the UE in the configured set of RA occasions.

The UE beamforms the RA-P 812 in different directions in different occasions as configured, and the D-MIMO AP(s) receives/monitors accordingly.

Information regarding RA-P reception is forwarded from the D-MIMO APs to the D-MIMO CPU, as illustrated by 814. This information may include the detected RA-P, signal quality (e.g., RSRP), etc.

Based on the signal quality, traffic load, etc. the D-MIMO CPU chooses the AP(s) that will be used to transmit the RAR, as illustrated by 816, and configures the selected AP(s), as illustrated by 818, to transmit the RAR using the appropriate RAR occasion (e.g., associated with the RA-P occasion for which the best RA-P signal quality was recorded).

The configured AP(s) will then perform transmission of the RAR, as illustrated by 822, and the UE will receive in the corresponding RA response occasion. The RAR may comprise the TTC, temporary identity of the UE, etc. The beam used to receive the RAR may be used by the UE in subsequent communication with the D-MIMO system.

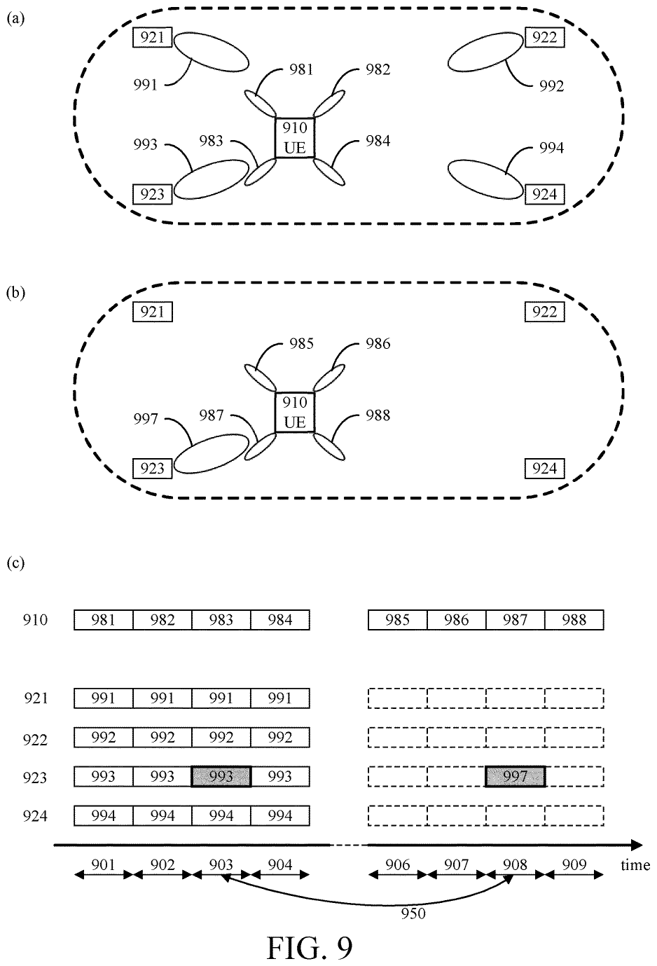

FIG. 9 schematically illustrates example operation of a radio access system and a UE according to some embodiments. For example, FIG. 9 may be seen as an exemplification of multi-directional transmission of a random access message by a wireless communication device (compare with step 320 of FIG. 3, and with step 620 of FIG. 6), and corresponding transmission of a reply by a D-MIMO AP (compare with step 330 of FIG. 3).

As illustrated by parts (a) and (c) of FIG. 9, a UE 910 performs multi-directional transmission of a random access message by using different time resources 901, 902, 903, 904 for different directions, as illustrated by 981, 982, 983, 984. Each AP 921, 922, 923, 924 in a first set of D-MIMO APs monitors the transmission of the random access message in each of the time resources 901, 902, 903, 904, as illustrated by 991, 992, 993, 994. It should be noted that the monitoring by an AP may comprise using more than one reception beam, although only one reception beam is shown for each AP in FIG. 9.

Based on monitor reports from the APs 921, 922, 923, 924, a D-MIMO CU can select one or more APs to form a second set of D-MIMO APs (compare with steps 630 of FIG. 6, and with steps 520, 530 of FIG. 5). For example, if the strongest reception of the random access message is detected by AP 923 for the time resource 903 corresponding to the directional transmission 983 (highlighted in gray), the CU may select AP 923 to be included in the second set of APs.

As illustrated by parts (b) and (c) of FIG. 9, a reply 997 to the random access message is transmitted by the AP(s) of the second set (here; 923). The reply 997 is transmitted in a time resource 908 which is associated with the time resource 903, as illustrated by 950. Corresponding associations may apply for each of the time resources 901, 902, 903, 904 (e.g., 901 may be associated with 906, 902 may be associated with 907, 903 may be associated with 908, and 904 may be associated with 909).

Using beams corresponding to those used for the multi-directional transmission, the UE 910 monitors the time resources in which a reply may be expected, wherein each beam is used for monitoring of a respective time resource 906, 907, 908, 909, as illustrated by 985, 986, 987, 988.

When a reply 997 is detected in a particular time resource 908, the UE 910 can deduce from the association 950 which direction it should apply for subsequent communication (compare with steps 330, 340 of FIG. 3); namely the direction 983 that was used for transmission of the random access message in time resource 903.

FIG. 9 may be seen as an example of how the D-MIMO system can estimate which AP(s) to use for communication with the UE (e.g., AP(s) with most favorable channel conditions, e.g., DL and UL RSRP, towards the UE).

Alternatively or additionally, FIG. 9 may be seen as an example of how the UE can determine which beam(s) to use for communication with the D-MIMO system (e.g., the best beam(s) towards AP(s), which may be different from the best beam towards the macro BS—compare with 292 of FIG. 2).

It should be noted, that the multi-directional transmission from the UE as exemplified by FIG. 9 is not applies in all embodiments. Contrarily, according to some embodiments, the UE transmits the random access message (e.g., msg1 or msg3) only in the same beam/direction it used to receive (e.g., system information signaling and/or msg2) from the radio access node (e.g., a macro BS).

In such embodiments, the AP(s) of the first set may be configured to monitor a single random access message resource, and there may be a single reply resource for transmission of the reply. Typically, only AP(s) in the first set that are between the UE and the radio access node (or close thereto) will detect the random access message in these embodiments.

Hence, the D-MIMO system may decide to not take over radio access responsibility even in cases where there are AP(s) that could serve the UE (if such AP(s) were not able to detect the random access message), or the D-MIMO system may decide to take over radio access responsibility using less than optimal AP(s) (if the optimal AP(s) were not able to detect the random access message).

Despite these drawbacks, this approach may be beneficial in some scenarios, since there is less signaling overhead than for the multi-directional transmission approach (e.g., according to FIG. 9). In fact, the signaling overhead of this approach for initial access towards the D-MIMO system may be equal to the signaling overhead of initial access towards the radio access node.

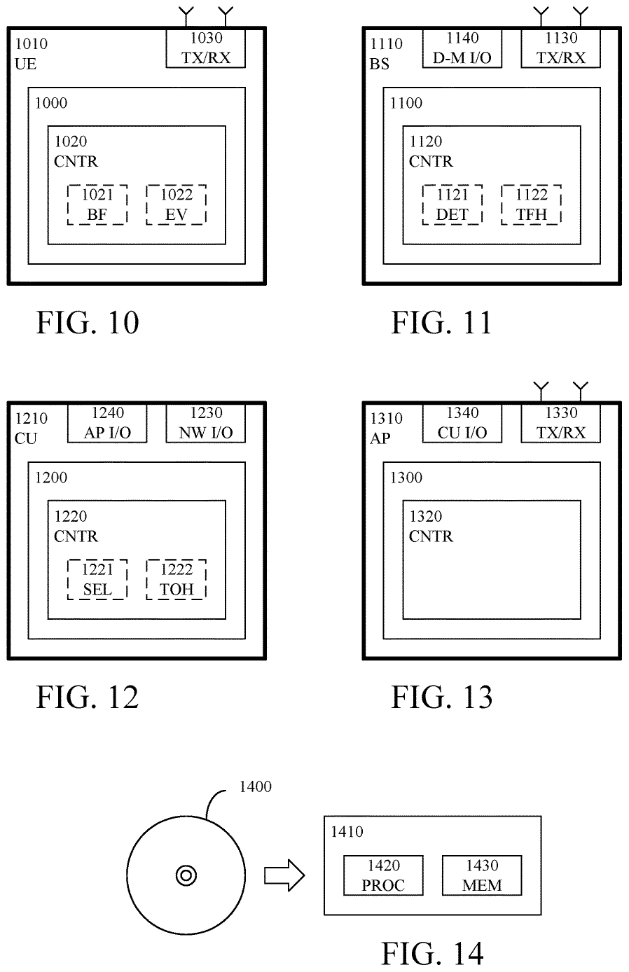

FIG. 10 schematically illustrates an example apparatus 1000 for a wireless communication device configured for operation in association with a communication network, wherein the communication network comprises a radio access node and a D-MIMO system.

For example, the apparatus 1000 may be comprised, or comprisable, in a wireless communication device, such as a UE 1010. Alternatively or additionally, the apparatus 1000 may be configured to perform, or cause performance of, one or more actions as described in connection with any of FIGS. 2, 3, 7, 8, and 9.

The apparatus 1000 comprises a controller 1020 (CNTR; e.g., controlling circuitry or a control module).

The controller 1020 is configured to cause reception, from the radio access node, of a configuration for multi-directional transmission of a random access message (compare with step 310 of FIG. 3), transmission of the random access message in two or more directions, using a respective random access message resource for each direction (compare with step 320 of FIG. 3), and reception, from an access point of the D-MIMO system, of a reply to the random access message in a reply resource (compare with step 330 of FIG. 3).

To this end, the controller 1020 may comprise, or be otherwise associated with (e.g., connected, or connectable, to), a transceiver 1030 (TX/RX; e.g., transceiving circuitry or a transceiver module) and a beamformer 1021 (BF; e.g., beamforming circuitry or a beamformer module). The transceiver 1030 may be configured to receive the configuration for multi-directional transmission, transmit the random access message in two or more directions, and receive the reply. The beamformer 1021 may be configured to control the transceiver 1030 for the transmission of the random access message in two or more directions.

The controller 1020 is also configured to case use of a specific direction for subsequent communication via the D-MIMO system (compare with step 340 of FIG. 3), wherein the specific direction is indicated by the reply resource by association with one of the respective random access message resources.

To this end, the controller 1020 may comprise, or be otherwise associated with (e.g., connected, or connectable, to), an evaluator 1022 (EV; e.g., evaluating circuitry or an evaluation module). The evaluator 1022 may be configured to infer the specific direction from the reply resource.

FIG. 11 schematically illustrates an example apparatus 1100 for a network node configured for operation within a communication network, wherein the communication network comprises a radio access node (e.g., the network node, or a radio access node associated with the network node) and a D-MIMO system.

For example, the apparatus 1100 may be comprised, or comprisable, in a network node, such as a BS 1110. Alternatively or additionally, the apparatus 1100 may be configured to perform, or cause performance of, one or more actions as described in connection with any of FIGS. 2, 4, 7, and 8.

The apparatus 1100 comprises a controller 1120 (CNTR; e.g., controlling circuitry or a control module).

In some embodiments, the controller 1120 is configured to cause determination to attempt radio access via the D-MIMO system (compare with step 420 of FIG. 4).

To this end, the controller 1120 may comprise, or be otherwise associated with (e.g., connected, or connectable, to), a determiner 1121 (DET; e.g., determining circuitry or a determination module). The determiner 1121 may be configured to determine to attempt radio access via the D-MIMO system.

The controller 1120 is configured to cause the D-MIMO system to monitor transmission of a random access message from a wireless communication device (compare with step 420 of FIG. 4); e.g., by transmission of a monitor request message, provision of random access resource information, and/or transmission of a monitor trigger message.

To this end, the controller 1120 may comprise, or be otherwise associated with (e.g., connected, or connectable, to), an interface 1140 towards the D-MIMO system (D-M I/O; e.g., interfacing circuitry or an interface module). The interface 1140 may, for example, be configured to convey a control signal to the D-MIMO system that configures/requests the D-MIMO system to monitor transmission of the random access message.

In some embodiments, the controller 1120 is configured to cause transmission, to the wireless communication device, of a configuration for multi-directional transmission of the random access message (compare with step 430 of FIG. 4).

To this end, the controller 1120 may comprise, or be otherwise associated with (e.g., connected, or connectable, to), a transceiver 1130 (TX/RX; e.g., transceiving circuitry or a transceiver module). The transceiver 1130 may be configured to transmit the configuration for multi-directional transmission.

The controller 1120 is also configured to cause transfer, to the D-MIMO system, of radio access responsibility for subsequent communication with the wireless communication device (compare with step 440 of FIG. 4).

To this end, the controller 1120 may comprise, or be otherwise associated with (e.g., connected, or connectable, to), a transfer handler 1122 (TFH; e.g., transfer handling circuitry or a transfer handling module). The transfer handler 1122 may be configured to transfer radio access responsibility to the D-MIMO system (e.g., by signaling through the interface 1140).

FIG. 12 schematically illustrates an example apparatus 1200 for a CU of a D-MIMO system configured for operation within a communication network, wherein the communication network comprises a radio access node and the D-MIMO system.

For example, the apparatus 1200 may be comprised, or comprisable, in a D-MIMO CU, such as a CU 1210. Alternatively or additionally, the apparatus 1200 may be configured to perform, or cause performance of, one or more actions as described in connection with any of FIGS. 5, 7, 8, and 9.

The apparatus 1200 comprises a controller 1220 (CNTR; e.g., controlling circuitry or a control module).

The controller 1220 is configured to cause configuration of a first set of APs of the D-MIMO system to monitor transmission of a random access message from a wireless communication device (compare with step 510 of FIG. 5), reception of respective monitor reports from the first set of APs (compare with step 520 of FIG. 5), and configuration of a second set of APs for subsequent communication with the wireless communication device (compare with step 540 of FIG. 5).

To this end, the controller 1220 may comprise, or be otherwise associated with (e.g., connected, or connectable, to), an interface 1240 towards the APs (AP I/O; e.g., interfacing circuitry or an interface module). The interface 1240 may, for example, be configured to convey (to the APs) control signals that configures them to monitor transmission of the random access message, and control signals configures them for subsequent communication. The interface 1240 may also be configured to receive the monitor reports.

The controller 1220 is also configured to cause selection of the second set of APs of the D-MIMO system based on the monitor reports (compare with step 530 of FIG. 5).

To this end, the controller 1220 may comprise, or be otherwise associated with (e.g., connected, or connectable, to), a selector 1221 (SEL; e.g., selecting circuitry or a selection module). The selector 1221 may be configured to select the second set of APs.

The controller 1220 is also configured to cause takeover of radio access responsibility for subsequent communication with the wireless communication device (compare with step 550 of FIG. 5).

To this end, the controller 1220 may comprise, or be otherwise associated with (e.g., connected, or connectable, to), a takeover handler 1222 (TOH; e.g., takeover handling circuitry or a takeover handling module). The takeover handler 1222 may be configured to takeover radio access responsibility from the radio access node (e.g., by signaling through an interface 1230 towards the communication network, NW I/O).

FIG. 13 schematically illustrates an example apparatus 1300 for an AP of a D-MIMO system configured for operation within a communication network, wherein the communication network comprises a radio access node and the D-MIMO system.

For example, the apparatus 1300 may be comprised, or comprisable, in a D-MIMO AP, such as an AP 1310. Alternatively or additionally, the apparatus 1300 may be configured to perform, or cause performance of, one or more actions as described in connection with any of FIGS. 6, 7, 8, and 9.

The apparatus 1300 comprises a controller 1320 (CNTR; e.g., controlling circuitry or a control module).

The controller 1320 is configured to cause reception, from a CU of the D-MIMO system, of a configuration to monitor a random access message from a wireless communication device (compare with step 610 of FIG. 6), transmission of a monitor report to the CU (compare with step 630 of FIG. 6), and reception, from the CU, of a configuration for subsequent communication with the wireless communication device (compare with step 640 of FIG. 6).

To this end, the controller 1320 may comprise, or be otherwise associated with (e.g., connected, or connectable, to), an interface 1340 towards the CU (CO I/O; e.g., interfacing circuitry or an interface module). The interface 1340 may, for example, be configured to receive control signals that configures the AP to monitor transmission of the random access message, and control signals that configures the AP for subsequent communication. The interface 1340 may also be configured to convey the monitor reports to the CU.

The controller 1320 is also configured to cause monitoring of the random access message from the wireless communication device (compare with step 620 of FIG. 6).

To this end, the controller 1320 may comprise, or be otherwise associated with (e.g., connected, or connectable, to), a transceiver 1330 (TX/RX; e.g., transceiving circuitry or a transceiver module). The transceiver 1330 may be configured to receive/monitor the random access message.

It should be noted that any feature or advantage mention herein in connection with one Figure or embodiment, is equally applicable (as suitable and mutatis mutandis) to other Figure(s) or embodiment(s) even if it is not explicitly mentioned in connection thereto.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus; such as a wireless communication device, a network node (e.g., a radio access node), a control unit for a D-MIMO system, or an access point for a D-MIMO system.

Embodiments may appear within an electronic apparatus (such as a wireless communication device, a network node, a control unit for a D-MIMO system, or an access point for a D-MIMO system) comprising arrangements, circuitry, and/or logic according to any of the embodiments described herein. Alternatively or additionally, an electronic apparatus (such as a wireless communication device, a network node, a control unit for a D-MIMO system, or an access point for a D-MIMO system) may be configured to perform one or more method steps according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 14 illustrates an example computer readable medium in the form of a compact disc (CD) ROM 1400. The computer readable medium has stored thereon a computer program comprising program instructions. The computer program is loadable into a data processor (PROC; e.g., a data processing unit) 1420, which may, for example, be comprised in an electronic apparatus (such as a wireless communication device, a network node, a control unit for a D-MIMO system, or an access point for a D-MIMO system) 1410. When loaded into the data processor, the computer program may be stored in a memory (MEM) 1430 associated with, or comprised in, the data processor. According to some embodiments, the computer program may, when loaded into, and run by, the data processor, cause execution of method steps according to, for example, any of the methods illustrated in FIGS. 3-6, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

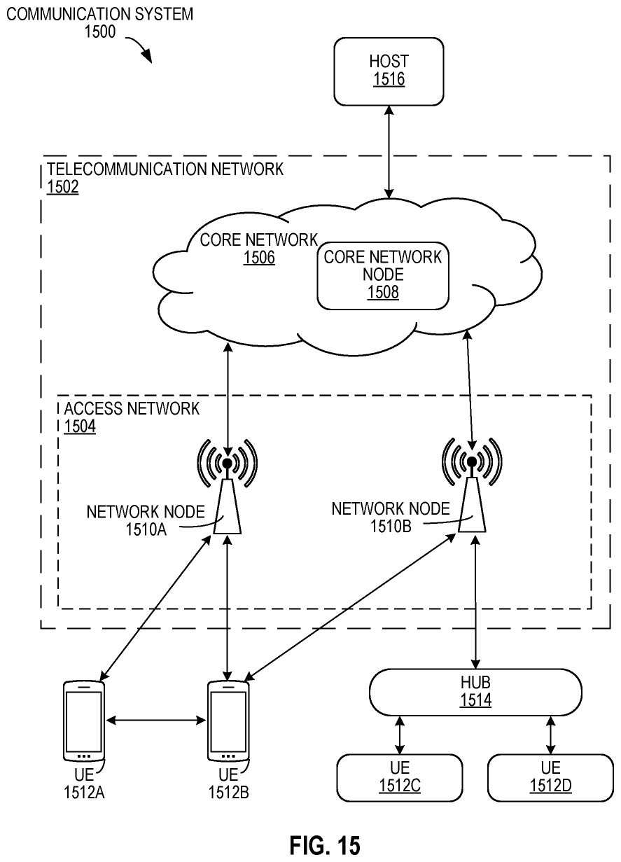

FIG. 15 shows an example of a communication system 1500 in accordance with some embodiments.

In the example, the communication system 1500 includes a telecommunication network 1502 that includes an access network 1504, such as a radio access network (RAN), and a core network 1506, which includes one or more core network nodes 1508. The access network 1504 includes one or more access network nodes, such as network nodes 1510a and 1510b (one or more of which may be generally referred to as network nodes 1510), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1502 includes one or more Open-RAN (O-RAN) network nodes. An O-RAN network node is a node in the telecommunication network 1502 that supports an O-RAN specification (e.g., a specification published by the O-RAN Alliance, or any similar organization) and may operate alone or together with other nodes to implement one or more functionalities of any node in the telecommunication network 1502, including one or more network nodes 1510 and/or core network nodes 1508.

Examples of an O-RAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an O-RAN specification). The network node may support a specification by, for example, supporting an interface defined by the O-RAN specification, such as an A1, F1, W1, E1, E2, X2, Xn interface, an open fronthaul user plane interface, or an open fronthaul management plane interface. Moreover, an O-RAN access node may be a logical node in a physical node. Furthermore, an O-RAN network node may be implemented in a virtualization environment in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1510 facilitate direct or indirect connection of user equipment (UE), such as by connecting UEs 1512a, 1512b, 1512c, and 1512d (one or more of which may be generally referred to as UEs 1512) to the core network 1506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1500 may include any number of wired or wireless networks, network nodes, UEs, and/or any other components or systems that may facilitate or participate in the communication of data and/or signals whether via wired or wireless connections. The communication system 1500 may include and/or interface with any type of communication, telecommunication, data, cellular, radio network, and/or other similar type of system.

The UEs 1512 may be any of a wide variety of communication devices, including wireless devices arranged, configured, and/or operable to communicate wirelessly with the network nodes 1510 and other communication devices. Similarly, the network nodes 1510 are arranged, capable, configured, and/or operable to communicate directly or indirectly with the UEs 1512 and/or with other network nodes or equipment in the telecommunication network 1502 to enable and/or provide network access, such as wireless network access, and/or to perform other functions, such as administration in the telecommunication network 1502.

In the depicted example, the core network 1506 connects the network nodes 1510 to one or more hosts, such as host 1516. These connections may be direct or indirect via one or more intermediary networks or devices. In other examples, network nodes may be directly coupled to hosts. The core network 1506 includes one more core network nodes (e.g., core network node 1508) that are structured with hardware and software components. Features of these components may be substantially similar to those described with respect to the UEs, network nodes, and/or hosts, such that the descriptions thereof are generally applicable to the corresponding components of the core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1516 may be under the ownership or control of a service provider other than an operator or provider of the access network 1504 and/or the telecommunication network 1502, and may be operated by the service provider or on behalf of the service provider. The host 1516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1502 is a cellular network that implements 3GPP standardized features. Accordingly, the telecommunications network 1502 may support network slicing to provide different logical networks to different devices that are connected to the telecommunication network 1502. For example, the telecommunications network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1512 are configured to transmit and/or receive information without direct human interaction. For instance, a UE may be designed to transmit information to the access network 1504 on a predetermined schedule, when triggered by an internal or external event, or in response to requests from the access network 1504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1514 communicates with the access network 1504 to facilitate indirect communication between one or more UEs (e.g., UE 1512c and/or 1512d) and network nodes (e.g., network node 1510b). In some examples, the hub 1514 may be a controller, router, content source and analytics, or any of the other communication devices described herein regarding UEs. For example, the hub 1514 may be a broadband router enabling access to the core network 1506 for the UEs. As another example, the hub 1514 may be a controller that sends commands or instructions to one or more actuators in the UEs. Commands or instructions may be received from the UEs, network nodes 1510, or by executable code, script, process, or other instructions in the hub 1514. As another example, the hub 1514 may be a data collector that acts as temporary storage for UE data and, in some embodiments, may perform analysis or other processing of the data. As another example, the hub 1514 may be a content source. For example, for a UE that is a VR headset, display, loudspeaker or other media delivery device, the hub 1514 may retrieve VR assets, video, audio, or other media or data related to sensory information via a network node, which the hub 1514 then provides to the UE either directly, after performing local processing, and/or after adding additional local content. In still another example, the hub 1514 acts as a proxy server or orchestrator for the UEs, in particular if one or more of the UEs are low energy IoT devices.

The hub 1514 may have a constant/persistent or intermittent connection to the network node 1510b. The hub 1514 may also allow for a different communication scheme and/or schedule between the hub 1514 and UEs (e.g., UE 1512c and/or 1512d), and between the hub 1514 and the core network 1506. In other examples, the hub 1514 is connected to the core network 1506 and/or one or more UEs via a wired connection. Moreover, the hub 1514 may be configured to connect to an M2M service provider over the access network 1504 and/or to another UE over a direct connection. In some scenarios, UEs may establish a wireless connection with the network nodes 1510 while still connected via the hub 1514 via a wired or wireless connection. In some embodiments, the hub 1514 may be a dedicated hub—that is, a hub whose primary function is to route communications to/from the UEs from/to the network node 1510b. In other embodiments, the hub 1514 may be a non-dedicated hub—that is, a device which is capable of operating to route communications between the UEs and network node 1510b, but which is additionally capable of operating as a communication start and/or end point for certain data channels.

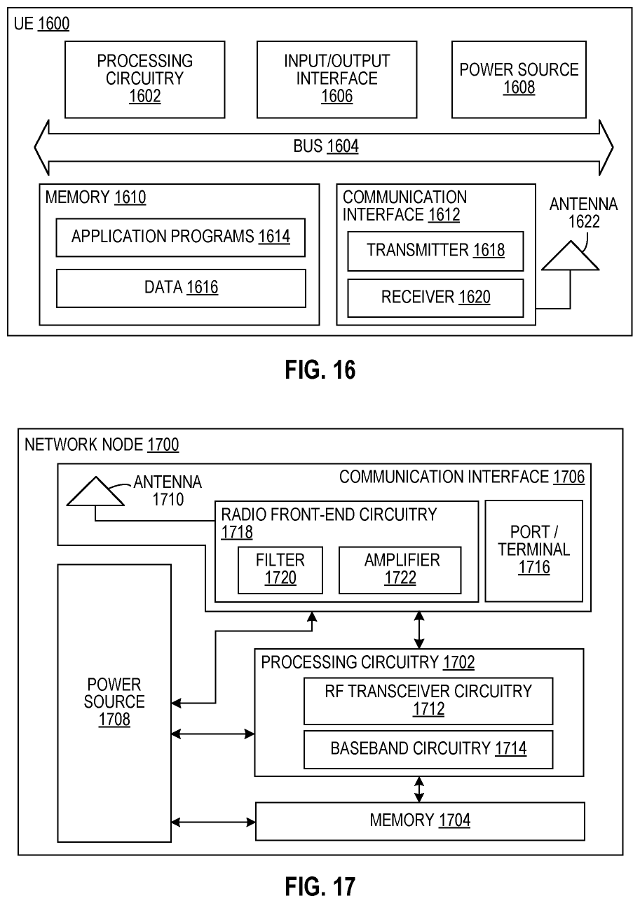

FIG. 16 shows a UE 1600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1600 includes processing circuitry 1602 that is operatively coupled via a bus 1604 to an input/output interface 1606, a power source 1608, a memory 1610, a communication interface 1612, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 1602 is configured to process instructions and data and may be configured to implement any sequential state machine operative to execute instructions stored as machine-readable computer programs in the memory 1610. The processing circuitry 1602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1602 may include multiple central processing units (CPUs).

In the example, the input/output interface 1606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1608 is structured as a battery or battery pack. Other types of power sources, such as an external power source (e.g., an electricity outlet), photovoltaic device, or power cell, may be used. The power source 1608 may further include power circuitry for delivering power from the power source 1608 itself, and/or an external power source, to the various parts of the UE 1600 via input circuitry or an interface such as an electrical power cable. Delivering power may be, for example, for charging of the power source 1608. Power circuitry may perform any formatting, converting, or other modification to the power from the power source 1608 to make the power suitable for the respective components of the UE 1600 to which power is supplied.

The memory 1610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1610 includes one or more application programs 1614, such as an operating system, web browser application, a widget, gadget engine, or other application, and corresponding data 1616. The memory 1610 may store, for use by the UE 1600, any of a variety of various operating systems or combinations of operating systems.

The memory 1610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1610 may allow the UE 1600 to access instructions, application programs and the like, stored on transitory or non-transitory memory media, to off-load data, or to upload data. An article of manufacture, such as one utilizing a communication system may be tangibly embodied as or in the memory 1610, which may be or comprise a device-readable storage medium.

The processing circuitry 1602 may be configured to communicate with an access network or other network using the communication interface 1612. The communication interface 1612 may comprise one or more communication subsystems and may include or be communicatively coupled to an antenna 1622. The communication interface 1612 may include one or more transceivers used to communicate, such as by communicating with one or more remote transceivers of another device capable of wireless communication (e.g., another UE or a network node in an access network). Each transceiver may include a transmitter 1618 and/or a receiver 1620 appropriate to provide network communications (e.g., optical, electrical, frequency allocations, and so forth). Moreover, the transmitter 1618 and receiver 1620 may be coupled to one or more antennas (e.g., antenna 1622) and may share circuit components, software or firmware, or alternatively be implemented separately.

In the illustrated embodiment, communication functions of the communication interface 1612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1600 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 1700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs).

Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1700 includes a processing circuitry 1702, a memory 1704, a communication interface 1706, and a power source 1708. The network node 1700 may be composed of multiple physically separate components (e.g., a NodeB component and a RNC component, or a BTS component and a BSC component, etc.), which may each have their own respective components. In certain scenarios in which the network node 1700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1700 may be configured to support multiple radio access technologies (RATs). In such embodiments, some components may be duplicated (e.g., separate memory 1704 for different RATs) and some components may be reused (e.g., a same antenna 1710 may be shared by different RATs). The network node 1700 may also include multiple sets of the various illustrated components for different wireless technologies integrated into network node 1700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1700.

The processing circuitry 1702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1700 components, such as the memory 1704, to provide network node 1700 functionality.

In some embodiments, the processing circuitry 1702 includes a system on a chip (SOC). In some embodiments, the processing circuitry 1702 includes one or more of radio frequency (RF) transceiver circuitry 1712 and baseband processing circuitry 1714. In some embodiments, the radio frequency (RF) transceiver circuitry 1712 and the baseband processing circuitry 1714 may be on separate chips (or sets of chips), boards, or units, such as radio units and digital units. In alternative embodiments, part or all of RF transceiver circuitry 1712 and baseband processing circuitry 1714 may be on the same chip or set of chips, boards, or units.

The memory 1704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1702. The memory 1704 may store any suitable instructions, data, or information, including a computer program, software, an application including one or more of logic, rules, code, tables, and/or other instructions capable of being executed by the processing circuitry 1702 and utilized by the network node 1700. The memory 1704 may be used to store any calculations made by the processing circuitry 1702 and/or any data received via the communication interface 1706. In some embodiments, the processing circuitry 1702 and memory 1704 is integrated.

The communication interface 1706 is used in wired or wireless communication of signaling and/or data between a network node, access network, and/or UE. As illustrated, the communication interface 1706 comprises port(s)/terminal(s) 1716 to send and receive data, for example to and from a network over a wired connection. The communication interface 1706 also includes radio front-end circuitry 1718 that may be coupled to, or in certain embodiments a part of, the antenna 1710. Radio front-end circuitry 1718 comprises filters 1720 and amplifiers 1722. The radio front-end circuitry 1718 may be connected to an antenna 1710 and processing circuitry 1702. The radio front-end circuitry may be configured to condition signals communicated between antenna 1710 and processing circuitry 1702. The radio front-end circuitry 1718 may receive digital data that is to be sent out to other network nodes or UEs via a wireless connection. The radio front-end circuitry 1718 may convert the digital data into a radio signal having the appropriate channel and bandwidth parameters using a combination of filters 1720 and/or amplifiers 1722. The radio signal may then be transmitted via the antenna 1710. Similarly, when receiving data, the antenna 1710 may collect radio signals which are then converted into digital data by the radio front-end circuitry 1718. The digital data may be passed to the processing circuitry 1702. In other embodiments, the communication interface may comprise different components and/or different combinations of components.

In certain alternative embodiments, the network node 1700 does not include separate radio front-end circuitry 1718, instead, the processing circuitry 1702 includes radio front-end circuitry and is connected to the antenna 1710. Similarly, in some embodiments, all or some of the RF transceiver circuitry 1712 is part of the communication interface 1706. In still other embodiments, the communication interface 1706 includes one or more ports or terminals 1716, the radio front-end circuitry 1718, and the RF transceiver circuitry 1712, as part of a radio unit (not shown), and the communication interface 1706 communicates with the baseband processing circuitry 1714, which is part of a digital unit (not shown).

The antenna 1710 may include one or more antennas, or antenna arrays, configured to send and/or receive wireless signals. The antenna 1710 may be coupled to the radio front-end circuitry 1718 and may be any type of antenna capable of transmitting and receiving data and/or signals wirelessly. In certain embodiments, the antenna 1710 is separate from the network node 1700 and connectable to the network node 1700 through an interface or port.

The antenna 1710, communication interface 1706, and/or the processing circuitry 1702 may be configured to perform any receiving operations and/or certain obtaining operations described herein as being performed by the network node. Any information, data and/or signals may be received from a UE, another network node and/or any other network equipment. Similarly, the antenna 1710, the communication interface 1706, and/or the processing circuitry 1702 may be configured to perform any transmitting operations described herein as being performed by the network node. Any information, data and/or signals may be transmitted to a UE, another network node and/or any other network equipment.

The power source 1708 provides power to the various components of network node 1700 in a form suitable for the respective components (e.g., at a voltage and current level needed for each respective component). The power source 1708 may further comprise, or be coupled to, power management circuitry to supply the components of the network node 1700 with power for performing the functionality described herein. For example, the network node 1700 may be connectable to an external power source (e.g., the power grid, an electricity outlet) via an input circuitry or interface such as an electrical cable, whereby the external power source supplies power to power circuitry of the power source 1708. As a further example, the power source 1708 may comprise a source of power in the form of a battery or battery pack which is connected to, or integrated in, power circuitry. The battery may provide backup power should the external power source fail.

Embodiments of the network node 1700 may include additional components beyond those shown in FIG. 17 for providing certain aspects of the network node's functionality, including any of the functionality described herein and/or any functionality necessary to support the subject matter described herein. For example, the network node 1700 may include user interface equipment to allow input of information into the network node 1700 and to allow output of information from the network node 1700. This may allow a user to perform diagnostic, maintenance, repair, and other administrative functions for the network node 1700.

The current RAN architecture for 5G defines base stations (or gNBs) comprising multiple component parts or nodes: a central unit (CU), one or more distributed units (DUs), and one or more radio units (RUs). The protocol layer stack of the base station is divided between the CU, the DUs and the RUs, with one or more lower layers of the stack implemented in the RUs, and one or more higher layers of the stack implemented in the CU and/or DUs. The CU is coupled to the DUs via a fronthaul higher layer split (HLS) network; the CU/DUs are connected to the RUs via a fronthaul lower-layer split (LLS) network.

In FIG. 17, network node 1700 includes processing circuitry 1702, device readable medium (comprised in memory 1704), interface 1706, and power source 1708. Although a network node may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1700 are depicted as single boxes located within a larger box, or nested within multiple boxes, in practice, a network node may comprise multiple different physical components that make up a single illustrated component (e.g., the device readable medium may comprise multiple separate hard drives as well as multiple RAM modules).

The network node 1700 may be configured to perform one or more method steps as described herein for a network node (e.g., in connection with FIG. 4). Alternatively or additionally, the network node 1700 may comprise the controller 1120 described in connection with FIG. 11.

According to embodiments of the disclosure, and as noted above, network node 1700 may be implemented with at least some of the following constituent parts or nodes: a CU, one or more DUs and one or more RUs. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node in the DL (i.e., from the CU to the RU) or received by the network node in the UL (i.e., from the RU to the CU).

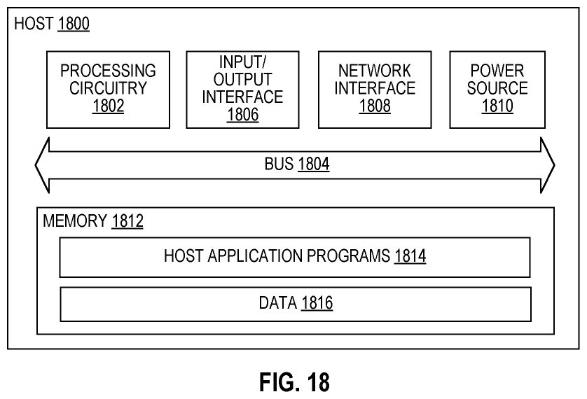

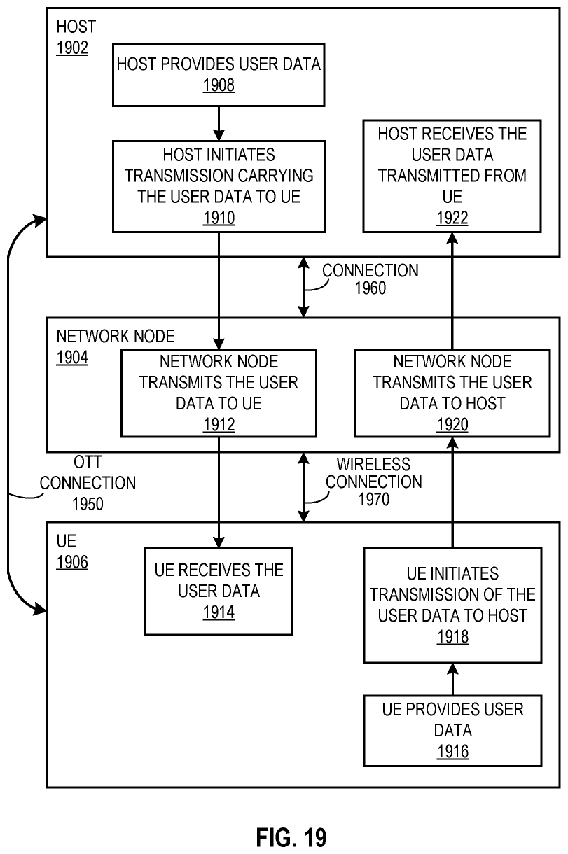

FIG. 18 is a block diagram of a host 1800, which may be an embodiment of the host 1516 of FIG. 15, in accordance with various aspects described herein. As used herein, the host 1800 may be or comprise various combinations hardware and/or software, including a standalone server, a blade server, a cloud-implemented server, a distributed server, a virtual machine, container, or processing resources in a server farm. The host 1800 may provide one or more services to one or more UEs.

The host 1800 includes processing circuitry 1802 that is operatively coupled via a bus 1804 to an input/output interface 1806, a network interface 1808, a power source 1810, and a memory 1812. Other components may be included in other embodiments. Features of these components may be substantially similar to those described with respect to the devices of previous figures, such as FIGS. 16 and 17, such that the descriptions thereof are generally applicable to the corresponding components of host 1800.

The memory 1812 may include one or more computer programs including one or more host application programs 1814 and data 1816, which may include user data, e.g., data generated by a UE for the host 1800 or data generated by the host 1800 for a UE. Embodiments of the host 1800 may utilize only a subset or all of the components shown. The host application programs 1814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1814 may also provide for user authentication and licensing checks and may periodically report health, routes, and content availability to a central node, such as a device in or on the edge of a core network. Accordingly, the host 1800 may select and/or indicate a different host for over-the-top services for a UE. The host application programs 1814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1512a of FIG. 15 and/or UE 1600 of FIG. 16), network node (such as network node 1510a of FIG. 15 and/or network node 1700 of FIG. 17), and host (such as host 1516 of FIG. 15 and/or host 1800 of FIG. 18) discussed in the preceding paragraphs will now be described with reference to FIG. 19.

Like host 1800, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1506 of FIG. 15) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment. More precisely, the teachings of these embodiments may improve the possibilities for co-existence between cellular communication and D-MIMO, and thereby provide benefits such as reduced signaling overhead in association with initial access for a D-MIMO system.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc. ; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### FIRST LIST OF EXAMPLES

1. A method for a wireless communication device configured for operation in association with a communication network, wherein the communication network comprises a radio access node and a distributed multiple-input multiple-output, D-MIMO, system, the method comprising:
   receiving (310), from the radio access node, a configuration (712, 810) for multi-directional transmission of a random access message;
   transmitting (320) the random access message (714, 812) in two or more directions, using a respective random access message resource (981, 982, 983, 984) for each direction;
   receiving (330), from an access point of the D-MIMO system, a reply (724, 822) to the random access message in a reply resource (987), wherein the reply resource indicates one of the two or more directions by being associated with one (983) of the respective random access message resources; and
   using (340) the indicated direction for subsequent communication via the D-MIMO system.
2. The method of example 1, wherein the configuration for multi-directional transmission of the random access message is comprised in a second random access protocol message (102, 712).
3. The method of any of examples 1 through 2, wherein the random access message is a third random access protocol message (103, 714).
4. The method of any of examples 1 through 3, wherein the reply to the random access message is a fourth random access protocol message (104, 724).
5. The method of example 1, wherein the configuration for multi-directional transmission of the random access message is comprised in a system information signaling (810).
6. The method of example 1, or example 5, wherein the random access message is a first random access protocol message (101, 812).
7. The method of example 1, or any of examples 5 through 6, wherein the reply to the random access message is a second random access protocol message (102, 826).
8. A method for a radio access node configured for operation within a communication network, wherein the communication network comprises the radio access node and a distributed multiple-input multiple-output, D-MIMO, system, the method comprising:
   causing (420) the D-MIMO system to monitor transmission of a random access message (714, 812) from a wireless communication device; and
   transferring (440, 722, 820), to the D-MIMO system, radio access responsibility for subsequent communication with the wireless communication device.
9. The method of example 8, further comprising determining (410, 706, 804) to attempt radio access via the D-MIMO system for the wireless communication device, wherein the D-MIMO system is caused to monitor transmission of the random access message from the wireless communication device responsive to the determination.
10. The method of example 9, wherein determining to attempt radio access via the D-MIMO system for the wireless communication device is responsive to a traffic load of the radio access node exceeding a load threshold, and/or responsive to a wireless communication device location indication falling within a coverage area of the D-MIMO system.
11. The method of any of examples 8 through 10, further comprising transmitting (430), to the wireless communication device, a configuration (712, 810) for multi-directional transmission of the random access message.
12. The method of example 11, wherein the configuration for multi-directional transmission of the random access message is comprised in a second random access protocol message (102, 712).
13. The method of any of examples 8 through 12, wherein causing the D-MIMO system to monitor transmission of the random access message from the wireless communication device comprises transmitting a monitor request message (708) to the D-MIMO system.
14. The method of any of examples 8 through 13, wherein the random access message is a third random access protocol message (103, 714).
15. The method of example 11, wherein the configuration for multi-directional transmission of the random access message is comprised in a system information signaling (810).
16. The method of any of examples 8 through 11, or example 15, wherein causing the D-MIMO system to monitor transmission of the random access message from the wireless communication device comprises providing random access resource information (802) to the D-MIMO system and/or transmitting a monitor trigger message (806) to the D-MIMO system.
17. The method of any of examples 8 through 11, or any of examples 15 through 16, wherein the random access message is a first random access protocol message (101, 812).
18. A method for a control unit, CU, of a distributed multiple-input multiple-output, D-MIMO, system configured for operation within a communication network, wherein the communication network comprises a radio access node and the D-MIMO system, the method comprising:
   configuring (510, 710, 808) a first set of access points, APs, of the D-MIMO system to monitor transmission of a random access message (714, 812) from a wireless communication device;
   receiving (520) respective monitor reports (716, 814) from the first set of APs;
   selecting (530, 718, 816) a second set of APs of the D-MIMO system based on the monitor reports;
   configuring (540, 720, 818) the second set of APs for subsequent communication with the wireless communication device; and
   taking over (550, 722, 820) radio access responsibility for subsequent communication with the wireless communication device.
19. The method of example 18, wherein the random access message is a third random access protocol message (103, 714).
20. The method of any of examples 18 through 19, further comprising receiving a monitor request message (708) from the radio access node, wherein configuring (710) the first set of APs is responsive to the reception of the monitor request.
21. The method of example 18, wherein the random access message is a first random access protocol message (101, 812).
22. The method of example 18, or example 21, further comprising receiving random access resource information (802) and/or a monitor trigger message (806) from the radio access node, wherein configuring (808) the first set of APs is responsive to the reception of the random access resource information and/or the monitor trigger message.
23. A method for an access point, AP, of a distributed multiple-input multiple-output, D-MIMO, system configured for operation within a communication network, wherein the communication network comprises a radio access node and the D-MIMO system, the method comprising:
   receiving (610), from a control unit, CU, of the D-MIMO system, a configuration (710, 808) to monitor a random access message (714, 812) from a wireless communication device;
   monitoring (620) the random access message from the wireless communication device;
   transmitting (630) a monitor report (716, 814) to the CU; and
   receiving (640), from the CU, a configuration (720, 818) for subsequent communication with the wireless communication device, wherein the subsequent communication comprises transmitting, to the wireless communication device, a reply (724, 822) to the random access message in a reply resource (997) associated with a random access message resource (993) in which the random access message was received during the monitoring.
24. The method of example 23, wherein the random access message is a third random access protocol message (103, 714).
25. The method of any of examples 23 through 24, wherein the reply to the random access message is a fourth random access protocol message (104, 724).
26. The method of example 23, wherein the random access message is a first random access protocol message (101, 812).
27. The method of example 23, or example 26, wherein the reply to the random access message is a second random access protocol message (102, 822).

28. A computer program product comprising a non-transitory computer readable medium (1400), having thereon a computer program comprising program instructions, the computer program being loadable into a data processing unit and configured to cause execution of the method according to any of examples 1 through 27 when the computer program is run by the data processing unit.
29. An apparatus for a wireless communication device configured for operation in association with a communication network, wherein the communication network comprises a radio access node and a distributed multiple-input multiple-output, D-MIMO, system, the apparatus comprising controlling circuitry (1020) configured to cause:
   reception, from the radio access node, of a configuration for multi-directional transmission of a random access message;
   transmission of the random access message in two or more directions, using a respective random access message resource for each direction;
   reception, from an access point of the D-MIMO system, of a reply to the random access message in a reply resource, wherein the reply resource indicates one of the two or more directions by being associated with one of the respective random access message resources; and
   use of the indicated direction for subsequent communication via the D-MIMO system.
30. The apparatus of example 29, wherein the configuration for multi-directional transmission of the random access message is comprised in a second random access protocol message.
31. The apparatus of any of examples 29 through 30, wherein the random access message is a third random access protocol message.
32. The apparatus of any of examples 29 through 31, wherein the reply to the random access message is a fourth random access protocol message.
33. The apparatus of example 29, wherein the configuration for multi-directional transmission of the random access message is comprised in a system information signaling.
34. The apparatus of example 29, or example 33, wherein the random access message is a first random access protocol message.
35. The apparatus of example 29, or any of examples 33 through 34, wherein the reply to the random access message is a second random access protocol message.
36. A wireless communication device comprising the apparatus of any of examples 29 through 35.
37. An apparatus for a radio access node configured for operation within a communication network, wherein
   the communication network comprises the radio access node and a distributed multiple-input multiple-output, D-MIMO, system, the apparatus comprising controlling circuitry (1120) configured to cause:
   the D-MIMO system to monitor transmission of a random access message from a wireless communication device; and
   transfer, to the D-MIMO system, of radio access responsibility for subsequent communication with the wireless communication device.
38. The apparatus of example 37, wherein the controlling circuitry is further configured to cause determination to attempt radio access via the D-MIMO system for the wireless communication device, wherein the D-MIMO system is caused to monitor transmission of the random access message from the wireless communication device responsive to the determination.
39. The apparatus of example 38, wherein determination to attempt radio access via the D-MIMO system for the wireless communication device is responsive to a traffic load of the radio access node exceeding a load threshold, and/or responsive to a wireless communication device location indication falling within a coverage area of the D-MIMO system.
40. The apparatus of any of examples 37 through 39, wherein the controlling circuitry is further configured to cause transmission, to the wireless communication device, of a configuration for multi-directional transmission of the random access message.
41. The apparatus of example 40, wherein the configuration for multi-directional transmission of the random access message is comprised in a second random access protocol message.
42. The apparatus of any of examples 37 through 41, wherein the controlling circuitry is configured to cause the D-MIMO system to monitor transmission of the random access message from the wireless communication device by causing transmission of a monitor request message to the D-MIMO system.
43. The apparatus of any of examples 37 through 42, wherein the random access message is a third random
44. The apparatus of example 40, wherein the configuration for multi-directional transmission of the random access message is comprised in a system information signaling.
45. The apparatus of any of examples 37 through 40, or example 44, wherein the controlling circuitry is configured to cause the D-MIMO system to monitor transmission of the random access message from the wireless communication device by causing provision of random access resource information to the D-MIMO system and/or transmission of a monitor trigger message to the D-MIMO system.
46. The apparatus of any of examples 37 through 40, or any of examples 44 through 45, wherein the random access message is a first random access protocol message.
47. A network node comprising the apparatus of any of examples 37 through 46.
48. An apparatus for a control unit, CU, of a distributed multiple-input multiple-output, D-MIMO, system configured for operation within a communication network, wherein the communication network comprises a radio access node and the D-MIMO system, the apparatus comprising controlling circuitry (1220) configured to cause:
   configuration of a first set of access points, APs, of the D-MIMO system to monitor transmission of a random access message from a wireless communication device;
   reception of respective monitor reports from the first set of APs;
   selection of a second set of APs of the D-MIMO system based on the monitor reports;
   configuration of the second set of APs for subsequent communication with the wireless communication device; and
   takeover of radio access responsibility for subsequent communication with the wireless communication device.
49. The apparatus of example 48, wherein the random access message is a third random access protocol message.
50. The apparatus of any of examples 48 through 49, wherein the controlling circuitry is further configured to cause reception of a monitor request message from the radio access node, wherein configuration of the first set of APs is responsive to the reception of the monitor request.
51. The apparatus of example 48, wherein the random access message is a first random access protocol message.
52. The apparatus of example 48, or example 51, wherein the controlling circuitry is further configured to cause reception of random access resource information and/or a monitor trigger message from the radio access node, wherein configuration of the first set of APs is responsive to the reception of the random access resource information and/or the monitor trigger message.
53. A control unit, CU, for a distributed multiple-input multiple-output, D-MIMO, system comprising the apparatus of any of examples 48 through 52.
54. An apparatus for an access point, AP, of a distributed multiple-input multiple-output, D-MIMO, system configured for operation within a communication network, wherein the communication network comprises a radio access node and the D-MIMO system, the apparatus comprising controlling circuitry (1320) configured to cause:
   reception, from a control unit, CU, of the D-MIMO system, of a configuration to monitor a random access message from a wireless communication device;
   monitoring of the random access message from the wireless communication device;
   transmission of a monitor report to the CU; and
   reception, from the CU, of a configuration for subsequent communication with the wireless communication device, wherein the subsequent communication comprises transmission, to the wireless communication device, of a reply to the random access message in a reply resource associated with a random access message resource in which the random access message was received during the monitoring.
55. The apparatus of example 54, wherein the random access message is a third random access protocol message.
56. The apparatus of any of examples 54 through 55, wherein the reply to the random access message is a fourth random access protocol message.
57. The apparatus of example 54, wherein the random access message is a first random access protocol message.
58. The apparatus of example 54, or example 57, wherein the reply to the random access message is a second random access protocol message.
59. An access point, AP, for a distributed multiple-input multiple-output, D-MIMO, system comprising the apparatus of any of examples 54 through 58.
60. A distributed multiple-input multiple-output, D-MIMO, system comprising the control unit, CU, of example 53 and a plurality of access points, APs, according to example 59.
61. A radio access system configured for operation within a communication network, wherein the radio access system comprises the network node of example 47 and the distributed multiple-input multiple-output, D-MIMO, system of example 60.

### SECOND LIST OF EXAMPLES

1. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform the following operations to transmit the user data from the host to the UE:
   causing a distributed multiple-input multiple-output, D-MIMO, system to monitor transmission of a random access message from the UE; and
   transferring, to the D-MIMO system, radio access responsibility for subsequent communication with the UE.
2. The host of the previous example, wherein:
   the processing circuitry of the host is configured to execute a host application that provides the user data; and
   the UE comprises processing circuitry configured to execute a client application associated with the host application to receive the transmission of user data from the host.
3. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs the following operations to transmit the user data from the host to the UE:
   causing a distributed multiple-input multiple-output, D-MIMO, system to monitor transmission of a random access message from the UE; and
   transferring, to the D-MIMO system, radio access responsibility for subsequent communication with the UE.
4. The method of the previous example, further comprising, at the network node, transmitting the user data provided by the host for the UE.
5. The method of any of the previous 2 examples, wherein the user data is provided at the host by executing a host application that interacts with a client application executing on the UE, the client application being associated with the host application.
6. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform the following operations to transmit the user data from the host to the UE:
   causing a distributed multiple-input multiple-output, D-MIMO, system to monitor transmission of a random access message from the UE; and
   transferring, to the D-MIMO system, radio access responsibility for subsequent communication with the UE.
7. The communication system of the previous example, further comprising:
   the network node; and/or
   the user equipment.
8. The communication system of the previous 2 examples, wherein:
   the processing circuitry of the host is configured to execute a host application, thereby providing the user data; and
   the host application is configured to interact with a client application executing on the UE, the client application being associated with the host application.
9. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform the following operations to receive the user data from the UE for the host, wherein the network node is a control unit, CU, of a distributed multiple-input multiple-output, D-MIMO, system:
   configuring a first set of access points, APs, of the D-MIMO system to monitor transmission of a random access message from the UE;
   receiving respective monitor reports from the first set of APs;
   selecting a second set of APs of the D-MIMO system based on the monitor reports;
   configuring the second set of APs for subsequent communication with the UE; and
   taking over radio access responsibility for subsequent communication with the UE.
10. The host of the previous 2 examples, wherein:
   the processing circuitry of the host is configured to execute a host application, thereby providing the user data; and
   the host application is configured to interact with a client application executing on the UE, the client application being associated with the host application.
11. The host of the any of the previous 2 examples, wherein the initiating receipt of the user data comprises requesting the user data.
12. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs the following operations to receive the user data from the UE for the host, wherein the network node is a control unit, CU, of a distributed multiple-input multiple-output, D-MIMO, system:
   configuring a first set of access points, APs, of the D-MIMO system to monitor transmission of a random access message from the UE;
   receiving respective monitor reports from the first set of APs;
   selecting a second set of APs of the D-MIMO system based on the monitor reports;
   configuring the second set of APs for subsequent communication with the UE; and
   taking over radio access responsibility for subsequent communication with the UE.
13. The method of the previous example, further comprising at the network node, transmitting the received user data to the host.
14. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE), wherein the UE comprises a communication interface and processing circuitry, the communication interface and processing circuitry of the UE being configured to perform the following operations to receive the user data from the host:
   receiving, from the cellular network, a configuration (for multi-directional transmission of a random access message;
   transmitting the random access message in two or more directions, using a respective random access message resource for each direction;
   receiving, from an access point of a D-MIMO system, a reply to the random access message in a reply resource, wherein the reply resource indicates one of the two or more directions by being associated with one of the respective random access message resources; and
   using the indicated direction for subsequent communication via the D-MIMO system.
15. The host of the previous example, wherein the cellular network further includes a network node configured to communicate with the UE to transmit the user data to the UE from the host.
16. The host of the previous 2 examples, wherein:
   the processing circuitry of the host is configured to execute a host application, thereby providing the user data; and
   the host application is configured to interact with a client application executing on the UE, the client application being associated with the host application.
17. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs the following operations to receive the user data from the host:
   receiving, from the cellular network, a configuration (for multi-directional transmission of a random access message;
   transmitting the random access message in two or more directions, using a respective random access message resource for each direction;
   receiving, from an access point of a D-MIMO system, a reply to the random access message in a reply resource, wherein the reply resource indicates one of the two or more directions by being associated with one of the respective random access message resources; and
   using the indicated direction for subsequent communication via the D-MIMO system.
18. The method of the previous example, further comprising:
   at the host, executing a host application associated with a client application executing on the UE to receive the user data from the UE.
19. The method of the previous example, further comprising:
   at the host, transmitting input data to the client application executing on the UE, the input data being provided by executing the host application,
   wherein the user data is provided by the client application in response to the input data from the host application.
20. A host configured to operate in a communication system to provide an over-the-top (OTT) service, the host comprising:
   processing circuitry configured to utilize user data; and
   a network interface configured to receipt of transmission of the user data to a cellular network for transmission to a user equipment (UE),
   wherein the UE comprises a communication interface and processing circuitry, the communication interface and processing circuitry of the UE being configured to perform the following operations to transmit the user data to the host:
   receiving, from the cellular network, a configuration (for multi-directional transmission of a random access message;
   transmitting the random access message in two or more directions, using a respective random access message resource for each direction;
   receiving, from an access point of a D-MIMO system, a reply to the random access message in a reply resource, wherein the reply resource indicates one of the two or more directions by being associated with one of the respective random access message resources; and
   using the indicated direction for subsequent communication via the D-MIMO system.
21. The host of the previous example, wherein the cellular network further includes a network node configured to communicate with the UE to transmit the user data from the UE to the host.
22. The host of the previous 2 examples, wherein:
   the processing circuitry of the host is configured to execute a host application, thereby providing the user data; and
   the host application is configured to interact with a client application executing on the UE, the client application being associated with the host application.
23. A method implemented by a host configured to operate in a communication system that further includes a network node and a user equipment (UE), the method comprising:
   at the host, receiving user data transmitted to the host via the network node by the UE, wherein the UE performs the following operations to transmit the user data to the host:
   receiving, from the cellular network, a configuration (for multi-directional transmission of a random access message;
   transmitting the random access message in two or more directions, using a respective random access message resource for each direction;
   receiving, from an access point of a D-MIMO system, a reply to the random access message in a reply resource, wherein the reply resource indicates one of the two or more directions by being associated with one of the respective random access message resources; and
   using the indicated direction for subsequent communication via the D-MIMO system.
24. The method of the previous example, further comprising:
   at the host, executing a host application associated with a client application executing on the UE to receive the user data from the UE.
25. The method of the previous examples, further comprising:
   at the host, transmitting input data to the client application executing on the UE, the input data being provided by executing the host application,
   wherein the user data is provided by the client application in response to the input data from the host application.

1-30. (canceled)

31. A method for a wireless communication device configured for operation in association with a communication network, wherein the communication network comprises a radio access node and a distributed multiple-input multiple-output (D-MIMO) system, the method comprising:
receiving, from the radio access node, a configuration for multi-directional transmission of a random access message;
transmitting the random access message in two or more directions, using a respective random access message resource for each direction;
receiving, from an access point of the D-MIMO system, a reply to the random access message in a reply resource, wherein the reply resource indicates one of the two or more directions by being associated with one of the respective random access message resources; and
using the indicated direction for subsequent communication via the D-MIMO system.

32. The method of claim 31, wherein the configuration for multi-directional transmission of the random access message is comprised in a second random access protocol message, and/or the random access message is a third random access protocol message, and/or the reply to the random access message is a fourth random access protocol message.

33. The method of claim 31, wherein the configuration for multi-directional transmission of the random access message is comprised in a system information signaling, and/or the random access message is a first random access protocol message, and/or the reply to the random access message is a second random access protocol message.

34. An apparatus for a wireless communication device configured for operation in association with a communication network, wherein the communication network comprises a radio access node and a distributed multiple-input multiple-output (D-MIMO) system, the apparatus comprising controlling circuitry configured to cause the apparatus to carry out the method of claim 31.

35. A method for a radio access node configured for operation within a communication network, wherein the communication network comprises the radio access node and a distributed multiple-input multiple-output (D-MIMO) system, the method comprising:
causing the D-MIMO system to monitor transmission of a random access message from a wireless communication device; and
transferring, to the D-MIMO system, radio access responsibility for subsequent communication with the wireless communication device.

36. The method of claim 35, further comprising determining to attempt radio access via the D-MIMO system for the wireless communication device, wherein the D-MIMO system is caused to monitor transmission of the random access message from the wireless communication device responsive to the determination.

37. The method of claim 36, wherein determining to attempt radio access via the D-MIMO system for the wireless communication device is responsive to a traffic load of the radio access node exceeding a load threshold, and/or responsive to a wireless communication device location indication falling within a coverage area of the D-MIMO system.

38. The method of claim 35, further comprising transmitting, to the wireless communication device, a configuration for multi-directional transmission of the random access message.

39. The method of claim 38, wherein the configuration for multi-directional transmission of the random access message is comprised in a second random access protocol message, and/or the random access message is a third random access protocol message.

40. The method of claim 35, wherein causing the D-MIMO system to monitor transmission of the random access message from the wireless communication device comprises transmitting a monitor request message to the D-MIMO system.

41. The method of claim 38, wherein the configuration for multi-directional transmission of the random access message is comprised in a system information signaling, and/or the random access message is a first random access protocol message.

42. The method of claim 35, wherein causing the D-MIMO system to monitor transmission of the random access message from the wireless communication device comprises providing random access resource information to the D-MIMO system and/or transmitting a monitor trigger message to the D-MIMO system.

43. A method for a control unit (CU) of a distributed multiple-input multiple-output (D-MIMO) system configured for operation within a communication network, wherein the communication network comprises a radio access node and the D-MIMO system, the method comprising:
configuring a first set of access points (APs) of the D-MIMO system to monitor transmission of a random access message from a wireless communication device;
receiving respective monitor reports from the first set of APs;
selecting a second set of APs of the D-MIMO system based on the monitor reports;
configuring the second set of APs for subsequent communication with the wireless communication device; and
taking over radio access responsibility for subsequent communication with the wireless communication device.

44. The method of claim 43, wherein the random access message is a third random access protocol message.

45. The method of claim 43, further comprising receiving a monitor request message from the radio access node, wherein configuring the first set of APs is responsive to the reception of the monitor request.

46. The method of claim 43, wherein the random access message is a first random access protocol message.

47. The method of claim 43, further comprising receiving random access resource information and/or a monitor trigger message from the radio access node, wherein configuring the first set of APs is responsive to the reception of the random access resource information and/or the monitor trigger message.

48. A method for an access point (AP) of a distributed multiple-input multiple-output (D-MIMO) system configured for operation within a communication network, wherein the communication network comprises a radio access node and the D-MIMO system, the method comprising:
receiving, from a control unit (CU) of the D-MIMO system, a configuration to monitor a random access message from a wireless communication device;
monitoring the random access message from the wireless communication device;
transmitting a monitor report to the CU; and
receiving, from the CU, a configuration for subsequent communication with the wireless communication device, wherein the subsequent communication comprises transmitting, to the wireless communication device, a reply to the random access message in a reply resource associated with a random access message resource in which the random access message was received during the monitoring.

49. The method of claim 48, wherein the random access message is a third random access protocol message, and/or the reply to the random access message is a fourth random access protocol message.

50. The method of claim 48, wherein the random access message is a first random access protocol message, and/or the reply to the random access message is a second random access protocol message.
